(19) United States
(12) Patent Application Publication
(10) Pub. No.: US 2026/0366289 A1
(43) Pub. Date: Nov. 19, 2026

(54) SNAP JOINT, FEMALE MEMBER THEREOF, AND METHOD OF USE

(71) Applicant: UNIVERSITE LAVAL, Quebec (CA)

(72) Inventors: André BÉGIN-DROLET, Québec (CA); Pierre BLANCHET, Québec (CA); Laurence PICARD, Québec (CA); Jonathan TALBOT, Lévis (CA)

(21) Appl. No.: 19/151,503

(22) PCT Filed: Jan. 31, 2024
(86) PCT No.: PCT/CA2024/050118

§ 371 Date: Jul. 28, 2025

(51) Int. Cl. E04B 1/348; F16B 5/06

(52) U.S. Cl. CPC E04B 1/3483; F16B 5/06

(57) ABSTRACT

The snap joint can have a male member having a shaft; a female member having a housing having an aperture configured for receiving the shaft along an engagement axis, the female member, a tumbler inside the housing, the tumbler having a plurality of stops; and a pair of locking members inside the housing and biased towards one another, the locking members having a plurality of abutments, the abutments being engaged with the stops, and opposing the bias, when the tumbler is at an armed position, and disengaged therefrom when the tumbler is moved from the armed position to an engagement position axially towards the distal end, in which engagement position the bias can move the locking members towards one another and into engagement with the male member.

### FIELD

This specification generally relates to the field of construction, more specifically of prefabricated and modular constructions and to a snap joint used during the on-site assembly of the construction.

### BACKGROUND

In the field of modular construction, sometimes referred to as prefabricated construction or prefab, individual components which will be referred to herein as modules are built within the factory and subsequently transported to the intended site to be assembled into the final product. The modules can include a number of walls as well as a ceiling and/or a flooring for instance, and can form an entire dwelling (e.g. a living or working quarter) designed for sharing a wall with one or more adjacent dwelling, or a portion of a dwelling destined to be assembled adjacent one or more other portions of the dwelling, for instance. A typical motivation behind this type of approach is to increase the amount of work that can be done in the controlled factory environment and reduce the amount of work to be done on-site. This usually results in lower overall costs, as the factory work is typically of lower cost in comparison to the work done on a construction site.

The modules are handled and shipped, typically individually, to the construction site, where they are assembled with one another to create the building or structure (see FIG. 1 for instance).

In their beginning, modular constructions were limited to the development of low-rise, temporary or portable buildings. However, with the development of the associated technologies and the success of some use cases modular construction concepts have gained in popularity and their use has become more and more widespread and extended to multi-storey applications and a wider range of building types.

While former modular construction concepts were satisfactory to a certain degree, there always remains room for improvement, particularly when aiming for bigger buildings.

### SUMMARY

In one example assembly process, such as is shown in FIG. 1 for instance, the modules are assembled by the skilled worker by first aligning the module with respect to the surrounding structure, and then fastening it in place. The placement of the module and its proper fastening typically ensures that appropriate rigidity and resistance between the modules are achieved, and that the construction is structurally sound as a whole, as well as sealed from the environment. The assembly process can require a significant amount of on-site workforce.

It was found that using snap joints can simplify the overall modular construction assembly process. However, to be acceptable in this type of application, a snap joint may need to comply with some or all of a number of potential requirements or specifications. Firstly, the snap joint may need to achieve a given level of structural strength once engaged, to ensure that the modules will not become disassembled over time or if extreme situations occur over time, as well as to ensure that the combined loadings of any one or more of self-weight, living-weight, snow-weight, wind forces and seismic forces can be withstood. Secondly, one may wish to reach a suitable pricing as otherwise, the cost of the snap joint may exceed the inconveniences of alternate methods of on-site assembly. Thirdly, one may wish for the snap joint to be simple to use in a manner to limit any required training and potentially reduce the likelihood of error, which can require some degree of ease of use and intuitiveness. It can be required, for instance, that the snap joint be designed in a manner for it to be virtually impossible to snap in any other configuration than a perfectly acceptable configuration and/or for the snap joint to emit a sound, like a strong click, upon snapping into the locket configuration, to provide a confirmation to the on-site workforce that the process has met its satisfactory end result. Fourthly, one may wish to limit the snap joint's footprint/volume in the construction. Indeed, a snap joint design may fail on the market simply because it does not satisfy the user's requirements on a single one these numerous points.

In accordance with one aspect, there is provided a female member of a snap joint for securing a first construction module to a second construction module on a modular construction site, the female member comprising: a housing having a cage structure having a proximal end opposite a distal end relative an engagement axis, the cage structure having an open periphery at the proximal end (an aperture surrounded peripherally by structure of the cage structure), and a support plate secured to the proximal end of the cage structure, the support plate having an aperture formed therein and configured to receive a shaft of a male member of the snap joint into the cage structure along the engagement axis; the support plate having an external ledge protruding from the cage structure away from the axis, the external ledge being configured for soldering to a periphery of a hollow structural section (HSS) steel structural beam when the cage structure is positioned inside the HSS steel structural beam; a tumbler inside the cage structure, the tumbler having a plurality of stops; a pair of locking members inside the cage structure and biased towards one another, the locking members having a plurality of abutments, the abutments being engaged with the stops and opposing the bias when the tumbler is at an armed position, and disengaged from the stops when the tumbler is moved from the armed position to an engagement position, in which engagement position the bias can move the locking members towards one another and into engagement with the male member.

In accordance with another aspect, there is provided a female member of a snap joint for securing a first construction module to a second construction module on a modular construction site, the female member comprising: a housing having a cage structure having a proximal end opposite a distal end relative an engagement axis, having an open periphery at the proximal end, and configured to receive a shaft of a male member of the snap joint into the cage structure along the engagement axis; configured for securing to a periphery of a hollow structural section (HSS) steel structural beam when the cage structure is positioned inside the HSS steel structural beam; a tumbler inside the cage structure, the tumbler having a plurality of stops; and a pair of locking members inside the cage structure and biased towards one another, the locking members having a plurality of abutments, the abutments being engaged with the stops and opposing the bias when the tumbler is at an armed position, and disengaged from the stops when the tumbler is moved from the armed position to an engagement position, in which engagement position the bias can move the locking members towards one another and into engagement with the male member.

In accordance with another aspect, there is provided a female member of a snap joint for securing a first construction module to a second construction module on a modular construction site, the female member comprising: a housing having a cage structure having a proximal end opposite a distal end relative an engagement axis, open at the proximal end, and configured to receive a shaft of a male member of the snap joint into the cage structure along the engagement axis via the proximal end, the cage structure positioned inside a hollow structural section (HSS) steel structural beam and secured thereto; a mechanism inside the cage structure, the mechanism having an armed position and an engaged position, the mechanism being operable to toggle from the armed position to the engaged position via the engagement of the shaft along the engagement axis, in which engaged position the mechanism engages the shaft and prevents retraction of the shaft from the cage structure.

In accordance with another aspect, there is provided a construction module configured to be assembled at a modular construction site, the construction module comprising: a rectangular parallelepiped shaped frame, the frame including a lower periphery, an upper periphery, and uprights connecting the lower periphery to the upper periphery; a first member of a snap joint secured to the upper periphery; a second member of the snap joint secured to the lower periphery, the second member of the snap joint being secured to the lower periphery, and having a plate extension penetrating underneath the lower periphery; a link structurally connecting the first member to the second member.

In accordance with another aspect, there is provided a female member of a snap joint securing a first construction module to a second construction module on a modular construction site, the female member comprising: a housing having a proximal end opposite a distal end relative an engagement axis, and an aperture, at the proximal end, configured to receive a shaft of a male member of the snap joint; a tumbler inside the housing, the tumbler having a plurality of stops; a pair of locking members inside the housing and biased towards one another, the locking members having a plurality of abutments, the abutments being engaged with the stops and opposing the bias when the tumbler is at an armed position, and disengaged from the stops when the tumbler is moved from the armed position to an engagement position, in which engagement position the bias can move the locking members towards one another and into engagement with the male member; and a spigot engaged with the aperture, with a retaining member having a stem securing the spigot to one of the cap of the tumbler and the distal end of the housing to hold the spigot into place until a time of installation.

The retaining member may be threadingly engaged with the distal end of the cage structure.

In accordance with another aspect, there is provided a female member of a snap joint for securing a first construction module to a second construction module on a modular construction site, the female member comprising: a housing having a proximal end opposite a distal end relative an engagement axis, and an aperture, at the proximal end, configured to receive a shaft of a male member of the snap joint, and a fixation plate protruding tangentially from a lateral face of the housing; a tumbler inside the housing, the tumbler having a plurality of stops; a pair of locking members inside the housing and biased towards one another, the locking members having a plurality of abutments, the abutments being engaged with the stops and opposing the bias when the tumbler is at an armed position, and disengaged from the stops when the tumbler is moved from the armed position to an engagement position, in which engagement position the bias can move the locking members towards one another and into engagement with the male member; and the housing being tightly received in a cavity defined in a mass timber structural beam of the first construction module, with the fixation plate overlapping portions of a first external face of the mass timber structural beam adjacent the cavity and the proximal end exposed on a second external face of the mass timber structural beam, and the fixation plate is secured to the mass timber structural beam.

In accordance with another aspect, there is provided a female member of a snap joint securing a first construction module to a second construction module on a modular construction site, the female member comprising: a housing having a proximal end opposite a distal end relative an engagement axis, and an aperture, at the proximal end, configured to receive a shaft of a male member of the snap joint, and protuberances protruding from a peripheral external face of the housing; a tumbler inside the housing, the tumbler having a plurality of stops; a pair of locking members inside the housing and biased towards one another, the locking members having a plurality of abutments, the abutments being engaged with the stops and opposing the bias when the tumbler is at an armed position, and disengaged from the stops when the tumbler is moved from the armed position to an engagement position, in which engagement position the bias can move the locking members towards one another and into engagement with the male member; and the housing being cast within a concrete structure, the concrete structure filling interstices between the protuberances and the area surrounding the housing except for the proximal end.

In accordance with another aspect, there is provided a female member of a snap joint for securing a first construction module to a second construction module on a modular construction site, the female member comprising: a housing having a cage structure having a proximal end opposite a distal end relative an engagement axis, the cage structure having an open periphery at the proximal end, and a support plate secured to the proximal end of the cage structure, the support plate having an aperture formed therein and configured to receive a shaft of a male member of the snap joint into the cage structure along the engagement axis; the support plate having an external ledge protruding from the cage structure away from the axis, the external ledge being configured for soldering to a periphery of a hollow external housing structure when the cage structure is positioned inside the hollow external housing structure with a proximal end of the hollow external housing structure in abutment with the external ledge; a tumbler inside the cage structure, the tumbler having a plurality of stops; a pair of locking members inside the cage structure and biased towards one another, the locking members having a plurality of abutments, the abutments being engaged with the stops and opposing the bias when the tumbler is at an armed position, and disengaged from the stops when the tumbler is moved from the armed position to an engagement position, in which engagement position the bias can move the locking members towards one another and into engagement with the male member.

The locking members may each have a radially broadening feature leading to their proximal end.

The proximal ends of the locking members may be engaged with a intermediary sheet material, the intermediary sheet material being harder than a material of the support plate, the intermediary sheet material overlaying the support plate.

The female member may have a fixation plate secured to and protruding tangentially from a face of the housing.

The female member may have protuberances protruding from a peripheral external face of the housing.

The housing may also have an external structural housing having a hollow body engaged around the cage structure, engaged and soldered to the external ledge.

The female member may further have fixation plate secured to and protruding tangentially from a face of the external structural housing.

The female member may further have protuberances protruding from a peripheral external face of the external structural housing.

In accordance with another aspect, there is provided a snap joint for securing a first construction module to a second construction module on a modular construction site, the snap joint comprising: a male member having a shaft; a female member having a housing having a proximal end opposite a distal end, and an aperture at the proximal end, the aperture configured for receiving the shaft along an engagement axis, a tumbler inside the housing, the tumbler having a cap proximate the distal end, and a plurality of prongs protruding axially from the cap, in a direction towards the distal end, the prongs terminating at free ends, the tumbler having a plurality of cap stops and a plurality of base stops, the prongs having a plurality of cap abutment recesses and the plurality of base stops; a pair of locking members inside the housing, each locking member of the pair on an opposite side of the axis, the locking members of the pair biased towards one another, and towards the axis, each locking member of the pair having a cap abutment and a base abutment, the base abutment provided in the form of tangentially oriented protrusions relative the axis, the cap abutments and base abutments being engaged with the cap stops and base stops, respectively, and opposing the bias, when the tumbler is at an armed position, and disengaged therefrom when the tumbler is moved from the armed position to an engagement position axially towards the distal end, in which engagement position the cap abutments are aligned with the cap abutment recesses, and the bias can move the locking members towards one another and into engagement with the male member.

Each prong may have a waist between the cap stop and the base stop, the waist forming the cap abutment recesses.

The plurality of cap stops may form part of the plurality of prongs.

The tumbler may have a plurality of base abutment recesses embodied as free areas adjacent the free ends of the prongs and configured to receive the base abutments when in the tumbler is in the engagement position.

The cap stops may be proximate the cap, and the base stops axially spaced apart from the cap stops, and adjacent the free ends, the cap abutment recesses adjacent the cap stops, between the cap stops and the base stops, with the cap abutment provided in the form of tangentially oriented protrusions relative the axis.

The base stop recesses may be provided in the form of tangentially narrowing portions of the locking members located axially between the base abutments and the cap abutments, the tangentially narrowing portions being narrower than a tangential width of the locking members at the tangentially oriented protrusions.

The male member may have a shaft engageable through the base stop of the tumbler, along the engagement axis, in a manner to push the tumbler out of interference with the locking members, thereby freeing the locking members to transversally engage with the shaft.

The bias may be exerted by a plurality of spring engaged between the housing and each one of the locking members.

Many further features and combinations thereof concerning the present improvements will appear to those skilled in the art following a reading of the instant disclosure.

### DESCRIPTION OF THE FIGURES

In the figures,

FIG. 1 is an oblique view of an assembly step of a module in a modular construction site in accordance with the prior art;

FIG. 2A is a partially exploded oblique view of a snap joint used to connect two modular pieces in accordance with the prior art;

FIG. 2B is the portion 2B-2B of FIG. 2A, shown enlarged;

FIG. 2C is an enlarged portion of the snap joint; and

FIG. 2D is a cross section view taken along lines 2D-2D of FIG. 3A;

FIGS. 3A, 3B and 3C are side sectional views of the snap joint in an initially disengaged position, engaged position and disengaged position after being released, respectively;

FIGS. 3D and 3E are views similar to FIG. 3B, but showing the load path in tension and in compression, respectively;

FIG. 4A-4K are various views showing a snap joint in accordance with an embodiment;

FIGS. 4L and 4M are schematic views showing an alternate configuration to the configuration schematized in FIGS. 4J and 4K;

FIGS. 5A to 5C present example orientations of use of male and female snap joint members;

FIGS. 5D and 5E present example orientations of use of two female snap joint members used in conjunction with a double-ended shaft male member;

FIG. 6 is an example of a double-ended shaft male member;

FIG. 7 is an example of a female snap joint member in an upright configuration and having a biasing member;

FIGS. 8A to 8C are various views showing a snap joint integration to a mass timber structure;

FIGS. 9A and 9B are views showing a snap joint integration to a concrete structure;

FIGS. 10A and 10B are views showing features associated to a proximal end of locking members;

FIGS. 11A and 11B are views showing a snap joint integration to a hollow structural section (HSS) structure;

FIGS. 12A and 12B are exploded views of a female snap joint member and of a male snap joint member in accordance with another embodiment;

FIGS. 13A to 13E are views showing a snap joint integration to a construction module adapted for lifting from above; and

FIG. 14 is a cross-sectional view of a female snap joint member in accordance with another embodiment.

### DETAILED DESCRIPTION

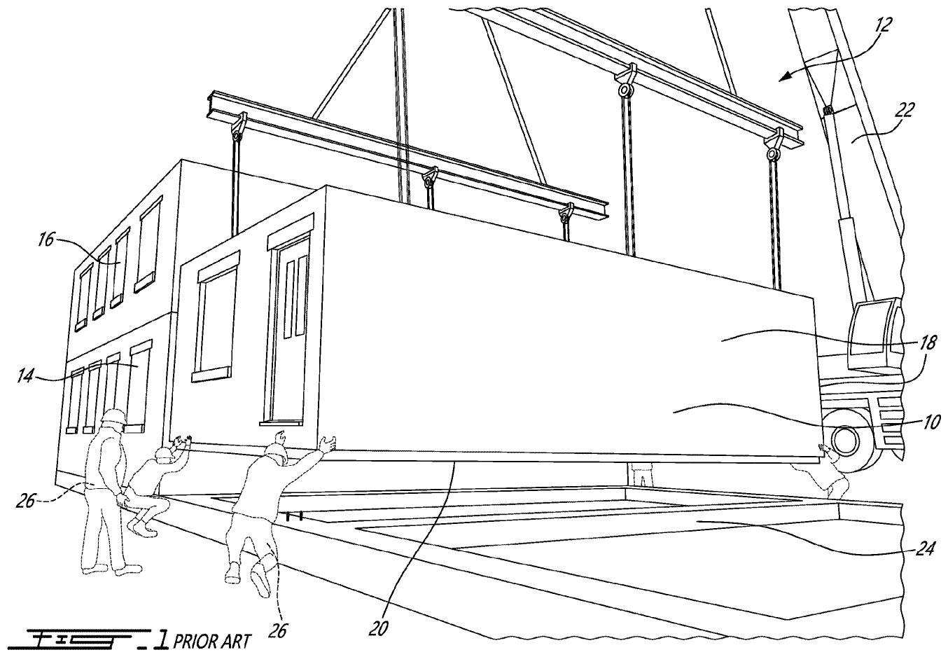

FIG. 1 shows an oblique view of an example construction module 10 being put into place in a modular construction 12 in accordance with the prior art. In this particular example, two other modules 14, 16 have previously been placed and secured in place within the modular construction, a lower module 14 and an upper module 16.

In this example, each of the modules 10 includes a plurality of walls 18 and flooring 20, and therefore maintains its structure independently during transportation and assembly, such as when hoisted by a crane 22, for instance. The floorings are all based on a similar type of construction, and the flooring of the following module, being placed above the previous module, can act as the vertical partition between the two modules. In other embodiments, the modules 10 can be provided with ceilings but without floors 20, for instance, with the ceiling of the module below also acting as its floor, or can be provided with both floors and ceilings. The modules 10 have an internal volume which is designed to act as a dwelling space, which can either be for lodging or for working, for instance. Depending on the embodiment, one or more modules 10 may form a single dwelling unit. The modules 10 are designed to be assembled to one another, typically both side-by-side and on one top of the other to form more complex structures at the construction site. Many alternate embodiments are possible, and depending on the embodiment, more or less components can be factory-installed into the modules, such as pluming, siding, roofing, electric fixtures and wires, internal finishing, doors, windows, etc.

As can be seen in FIG. 1, in this example, the module 10 to be placed is being hoisted by the crane 22 to the appropriate location on a foundation 24 of the modular construction 12 in lateral abutment with the lower module 14 having been previously placed. The foundation 24 may be designed specifically in dimensions configured to accommodate the dimensions of the module 10. Once laid in a correct position, the module 10 can be secured to the foundation 24, and a following module 10 can be placed above it, similarly as the upper module 16 has been placed above the lower module 14. The superposed modules can be designed with suitable features allowing the walls of the superposed module to be precisely aligned with the walls of the lower module.

The modules 10 can be fastened and interconnected with surrounding structures, which can be construction foundations 24, other similar modules 14, 16 and/or different modules such as modular walls or modular ceilings for instance. Typically, this was done via the use of fasteners, brackets, and other intermediary equipment by the workers 26. As will now be explained, it was found that at least in some embodiments, using snap joints can be better than the former techniques.

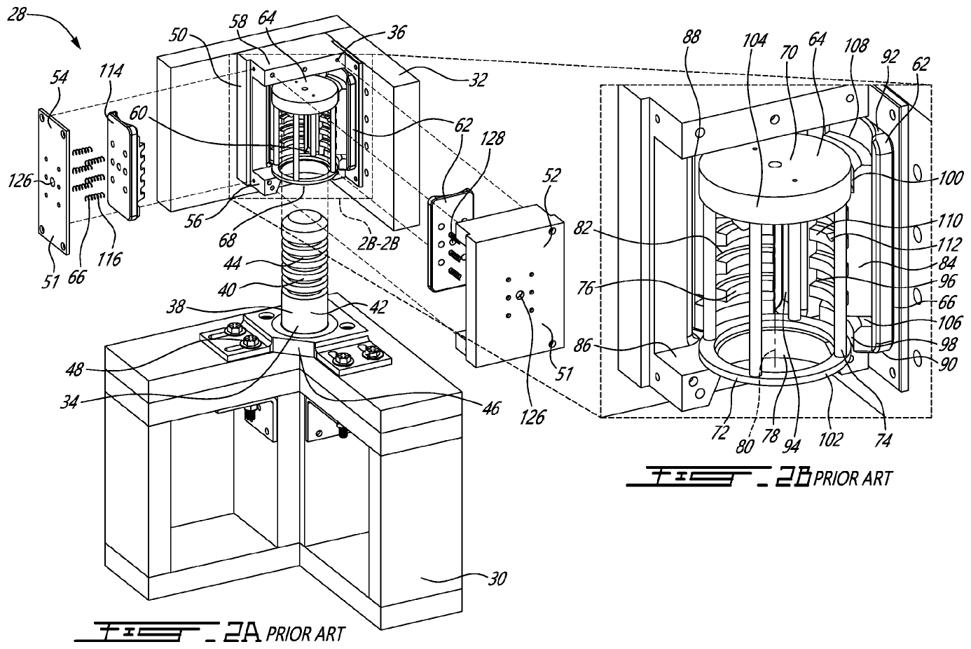

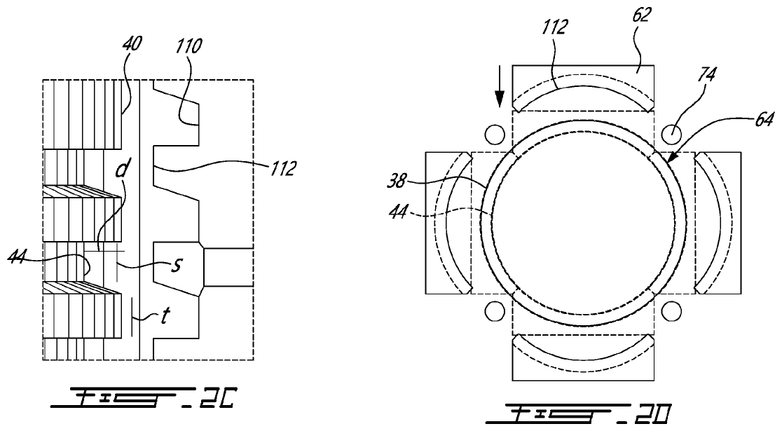

Attention is now brought to FIG. 2A, showing an example snap joint 28 in accordance with a prior art embodiment. FIG. 2A shows a partially exploded oblique view, where the snap joint 28 is being used to connect a first module 30 and a second module 32 to one another. The snap joint 28 includes a male member 34 mounted to the first module 30 and a female member 36 mounted on the second module 32. As will further be discussed below, the male member 34 can be inserted into the female member 36 and locked into place by the female member 36 such as to secure the first module 30 to the second module 32.

In this particular example, the second module 32 is configured to be assembled above the first module 30. For the sake of clarity, only part of the first module 30 and second module 32 are shown in FIG. 2A, where the part of the first module 30 shown can correspond to a top corner of a first module 30 wall, whereas the part of the second module 32 shown can correspond to the corresponding bottom corner of a second module 32 flooring area, for instance. It is understood that, while the snap joint 28 is shown used in the connection of a corner of two modules 30, 32 in this example, the snap joint 28 may be placed anywhere on the modules 30,32, in any suitable position and orientation. For instance, the male 34 and female 36 members of the snap joint 28 can be placed laterally along corresponding support beams of modules 30, 32 to be assembled side-by-side. Further, it is understood that one or both parts of the snap joint 28 can be mounted, made integral to or otherwise associate to other structural elements of the modular construction. For instance, in some circumstances, the male member 34 of the snap joint 28 can be made integral to the foundation (24 in FIG. 1) of the modular construction, such as to permit assembly of a module (10 in FIG. 1) directly to the foundation (24 in FIG. 1).

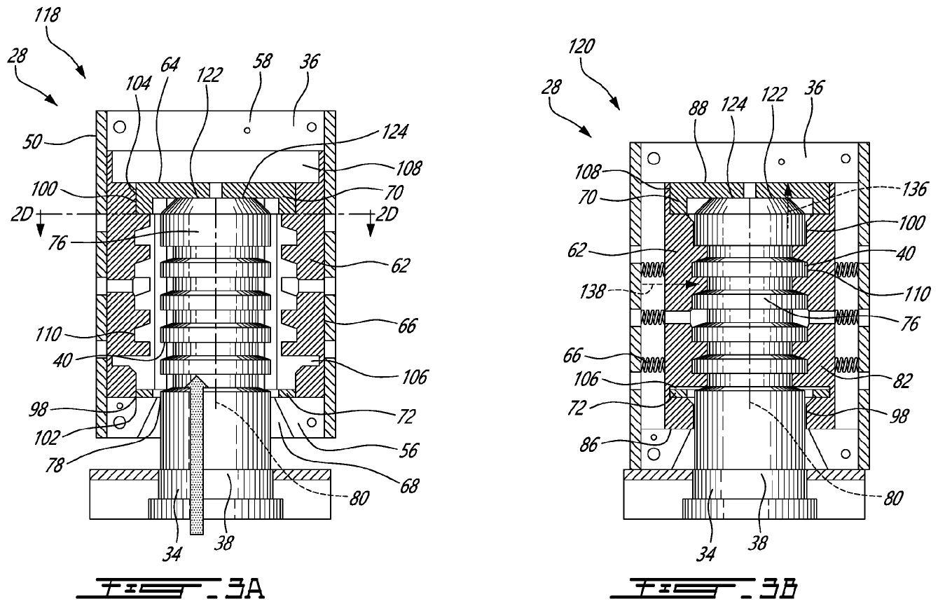

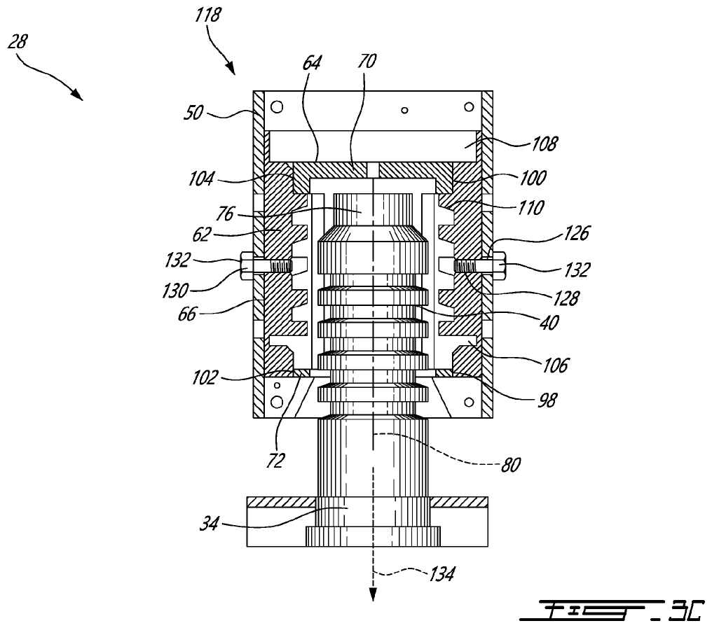

Still referring to FIG. 2A, the male member 34 has a shaft 38 having a length extending away from the first module 30, in an orientation which will be referred to herein as “lengthwisely”. The shaft 38 is configured to be lengthwisely received within the female member 36 (see FIG. 3A) and engaged by locking members 62 (see FIG. 3B) such as to lock the shaft 38 in place when fully inserted. The engagement of the male member 34 with the female member 36 permits the joining of the first module 30 to the second module 32.

The shaft 38 has a first locking feature 40 defined transversally along its external face 42, while the locking members 62 include a second locking feature 110 transversally defined along its internal surface 96. The first locking feature 40 and second locking feature 110 being complementary to one another. In this particular example, the first locking feature 40 is provided in the form of a plurality of locking channels 44 extending circumferentially along the external face 42 and being lengthwisely offset from one another, defining a generally female portion. The second locking feature 110 is provided in the form of a plurality of ribs 112 extending transversally from the internal surface 96 and being lengthwisely offset from one another, defining a generally male portion. The channels 44 and ribs 112 have complementary rectangular profiles and are configured such that the male portion (the ribs 112 in this embodiment), can be received within and engage with the female portion (i.e. the channels 44 in this embodiment).

It will be understood that other suitable locking features can be used for the first locking feature 40 and the second locking feature 110 in alternate embodiments. For instance, the male and female portions can be inversed such that the first locking feature 40 includes the male portion configured to be received in the female portion found on the second locking feature 110. In another alternate embodiment, the first locking feature 40 and second locking feature 110 can have a single channel and a single rib that engages with one another. In yet another embodiment, the channel 44 of the first locking feature 40 and the rib 112 of the second locking feature 110 can have a profile differing from the generally rectangular profile. In yet another embodiment, the first locking feature 40 and second locking feature can both have a combination of male portions and female portions made complementary to one another.

More specifically, as evidenced in FIG. 2C, the radially outer face of the shaft 38 has a crenellated cylindrical shape with a series of annular ribs and grooves extending linearly along its length. The dimension of the radial depth d of the grooves, relative the outer face of the ribs, is comparable to the axial dimension of the spacing s between two ribs (e.g. within 5 or 10%) in the illustrated embodiment. The axial dimension of the thickness t of the ribs is somewhat greater than the radial depth d of the grooves, by a factor of roughly 20-40%. The face of the ribs which are directed towards the cap 88 are provided with a slight slope, such as between 10 and 30 degrees in this embodiment, which can allow to act as a ratchet gear rack to a certain extent in this embodiment.

The radially inner face of each locking member of the cooperating locking member pair(s) can have a corresponding crenellated shape, which, in an embodiment having a generally cylindrical, axially crenellated shaft, can be arc-shaped around the axis in a manner to closely match the corresponding portion of the shaft, such as perhaps most clearly seen in the cross-sectional view presented in FIGS. 2B and 2D. The crenelated shape can have a series of annular ribs and grooves in the axial orientation. The dimensions of the crenelated shape of the locking members can be adapted to receive the crenelated shape of the shaft's outer face. To this end, the grooves of the locking members can be sized to tightly receive the ribs of the shaft, and the ribs of the locking members can be sized to tightly engage the grooves of the shaft. The face of the ribs of the locking members which face (in the axial orientation) towards the aperture can be slightly sloped, such as between 10 and 30 degrees in this embodiment, so as to operate as a multi-pronged pawl when cooperating in a ratchet-type action with the ratchet gear rack formed by the shaft.

In this example, the shaft 38 is made integral to a base 46. The base 46 being fastened to the first module 30 using fasteners 48. It is understood that the male member 34 can be mounted to the first module 30 by any suitable means and that, in alternate embodiments, the shaft 38 may be made integral to the first module 30 such as to omit the use of a base 46.

Still referring to FIG. 2A, the female member 36 comprises a housing 50 with a plurality of housing walls 51, a base end 56 and a cap end 58 defining a cavity 60. The female member 36 housing the locking members 62, a tumbler 64, and biasing members 66 within the housing 50. The base end 56 includes an aperture 68 configured to lengthwisely (i.e. axially if using a cylindrical coordinate system for convenience) receive the shaft 38 of the male member 34 within the cavity 60 of the housing 50.

In this specific example embodiment, the housing walls 51 include two housing segments 52 configured to be mounted to the second module 32 and to each other to define opposite sides of the housing walls 51. The housing further includes two side walls 54 configured to be mounted orthogonally to the housing segments 52. In this particular example, the base end 56 and the cap end 58 are partially defined on each of the housing segments 52, being integral to and extend transversally from the housing segments 52 such as to make the cap end 58 and the base end 56 whole when the housing segments 52 are assembled. Other configurations are possible in alternate embodiments. The base end 56 and the cap end 58 are lengthwisely separate from one another at opposite ends of the housing 50, encompassing the housing cavity 60 between the base end 56 and the cap end 58. In an alternate embodiment, the side walls can be absent.

It is understood that alternate housing structures can be used without departing from the present disclosure. For instance, in an alternate embodiment, one or various of the side walls 54 can also be mounted to the second module 32. In yet another embodiment, the base end 56 and/or cap end 58 can be separate from the housing segments 52 and configured to be assembled to the housing walls 51 separate from the housing segments 52. In yet another embodiment, the housing 50 can be machined from a singular piece of material, wherein the cavity 60 is machined via the introduction of the machining tool through the aperture 68 at the base end 56 of the housing 50 for instance.

Attention is now directed to FIG. 2B, showing the portion 2B-2B of FIG. 2A, enlarged, where the features of the locking members 62 and the tumbler 64 within the housing cavity 60 are seen. The locking members of a given pair, while transversally (radially if using a cylindrical coordinate system for convenience) biased towards one another, can be temporarily held apart from one another in a housing by the tumbler.

In this example, the tumbler 64 has two levels which can be referred to herein as a cap stop 70 and a base stop 72. The base stop and the cap stop can be longitudinally (axially in a cylindrical coordinate system) spaced-apart from one another. The base stop and the cap stop can be connected to each other via rigid links 74. In this embodiment, a tumbler cavity 76 is defined within the tumbler. The cap stop 70 is close to the cap end 58 of the housing 50 whereas the base stop 72 is closer to the base end 56 of the housing 50. In this specific embodiment, the cap stop 70 has a solid cylindrical structure. The base stop 72 has a (continuous) annular structure defining a tumbler aperture 78 which is configured to receive the shaft 38 of the male member 34 within. A trigger path 80 is lengthwisely (axially) defined and extends between the base stop 72 and the cap stop 70 of the tumbler 64, within the tumbler cavity 76. The tumbler 64 includes transversal openings 82, or “windows” which are defined axially between the cap and the annular structure, and circumferentially between pairs of adjacent links 74 connecting the cap stop 70 and the base stop 72. The links 74 can be seen to be provided here in the form of axially oriented prongs which protrude from the cap of the tumbler in the axial direction towards the aperture. As will further be discussed below, the transversal openings 82 permit the second locking feature 110 of the locking members 62 to extend within the tumbler cavity 76 when the female member is to engage the male member.

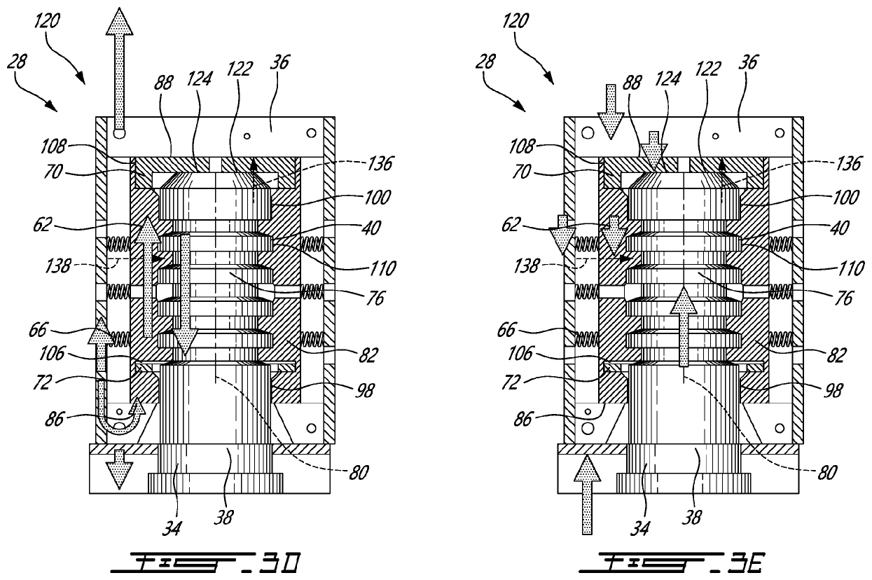

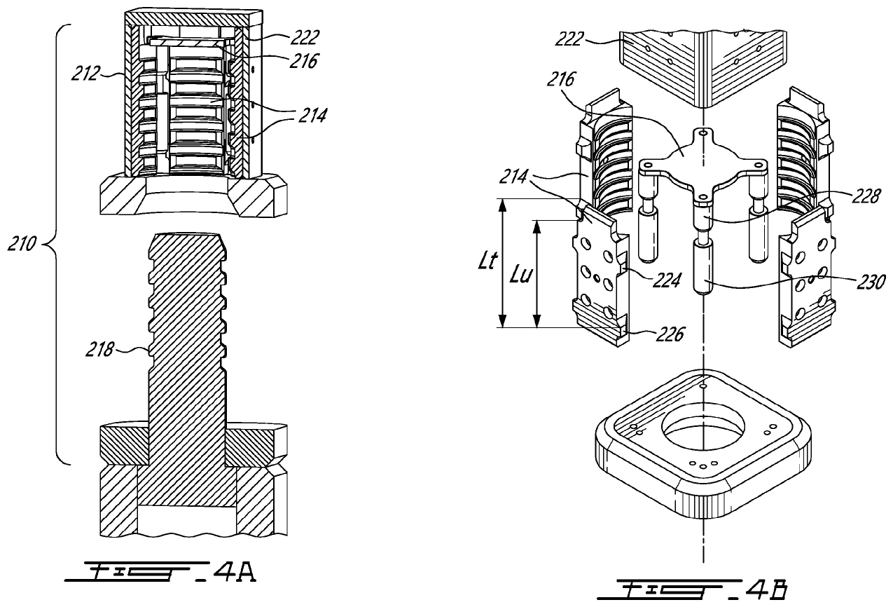

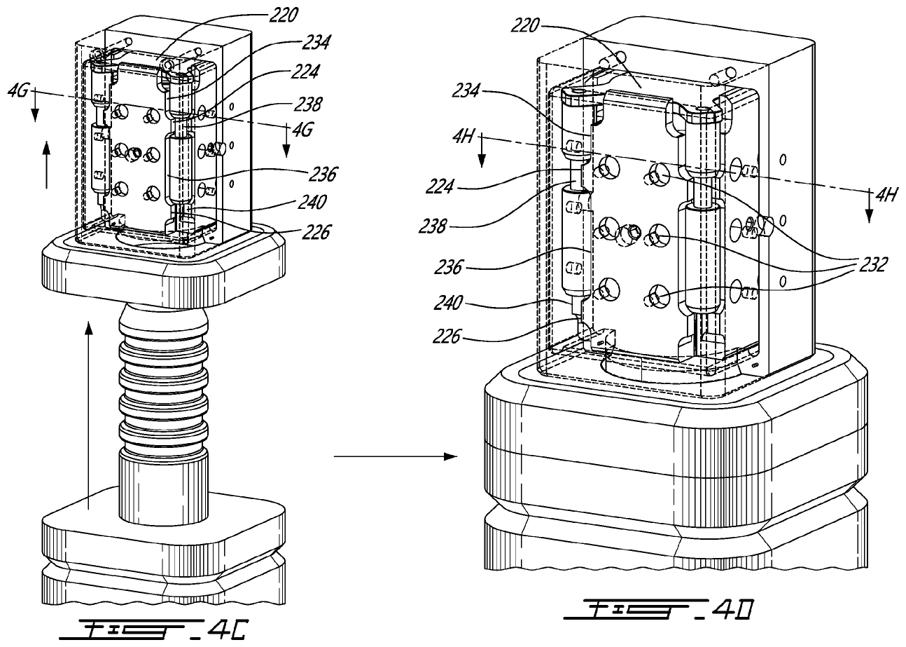

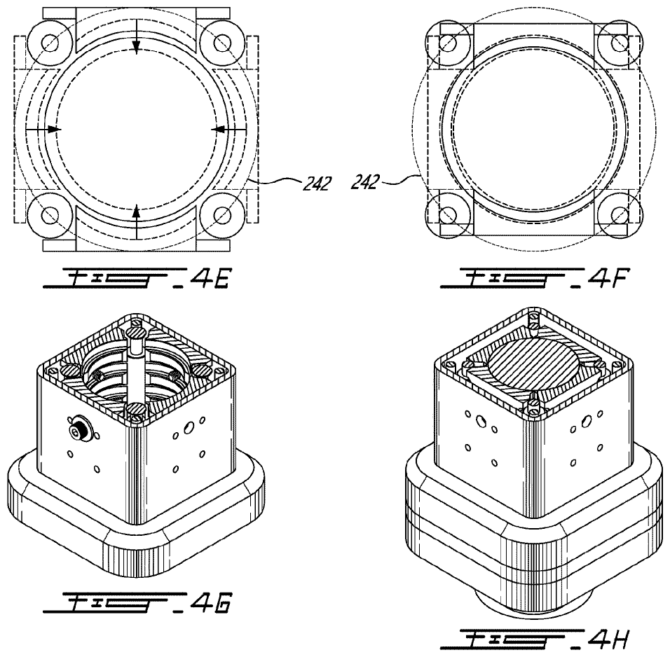

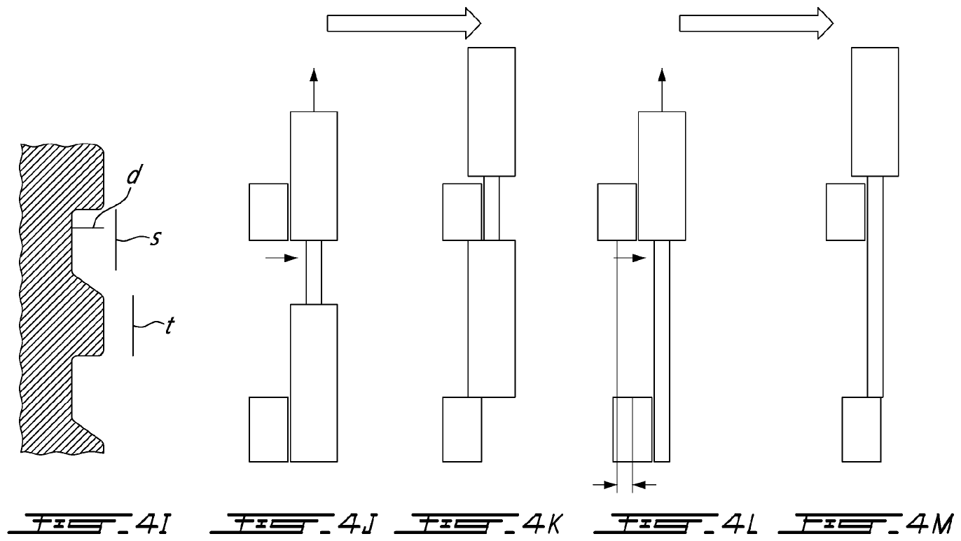

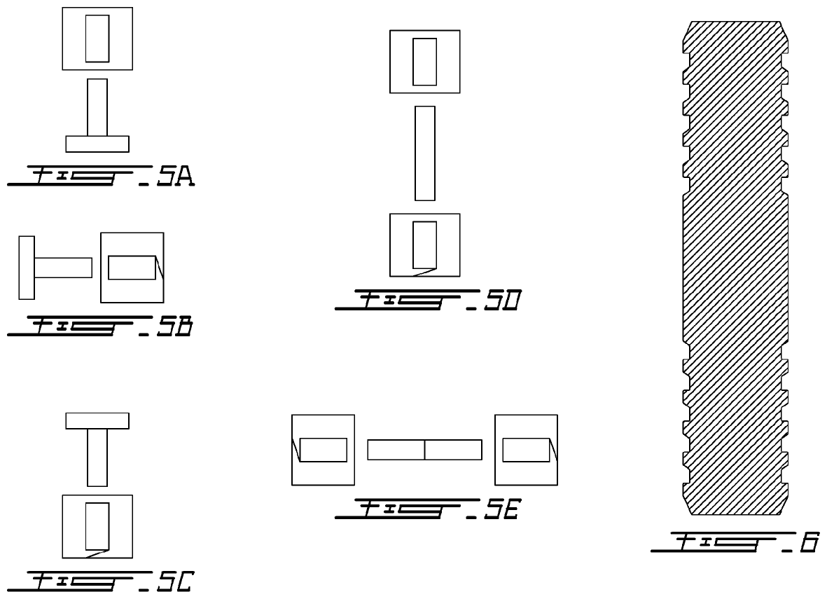

In this particular example and as perhaps best seen in FIG. 2B, the cap stop 70 and base stop 72 have corresponding outer diameters and are connected to one another by four rigid cylindrical links 74 circumferentially offset from one another around the base stop 72 and the cap stop 70. The tumbler 64 includes four transversal openings 82 leading to the tumbler cavity 76 between the adjacent links 74. It will, however, be understood that varying amount of links 74 and transversal openings 82 can be used in alternate embodiments. For instance, in an embodiment having 3 pairs of locking members in a hexagonal configuration, 6 links may be provided, one between each adjacent locking members, and correspondingly, 6 transversal openings, or “windows”, to accommodate the radial movement path of respective ones of the 6 locking members. As another example, an embodiment presented in FIGS. 4A and 4B of published patent application no. US 2022/0178135 has a single pair of locking members in a face-to-face configuration.

As will be further discussed below, the tumbler aperture 78 is aligned with the base end aperture 68 of the housing 50, such as to permit the insertion of the shaft 38 within the tumbler cavity 76 along the trigger path 80, through the housing aperture 68 and the tumbler aperture 78, and into the tumbler cavity.

As described above, the locking members 62 are housed within the housing 50. The locking members 62 comprise a generally rectangular and planar body 84. The plane associated to the planar shape of the body 84 is oriented lengthwisely and transversally to the orientation of engagement (i.e. axially and tangentially if using a cylindrical coordinate system for convenience), with the grooves penetrating into a face of the body which faces the other locking member of the corresponding pair. The body 87 extends lengthwisely from the internal face of the base end 86 of the housing 50 to the internal face of the cap end 88 of the housing 50. The base surface 90 of the locking member 62 abutting with the internal face of the base end 86 of the housing 50, and the cap surface 92 of the locking member 62 abutting with the internal face of the cap end 88 of the housing 50. The locking members 62 being lengthwisely (axially) trapped within the housing 50, while slidable transversally (radially) along the internal face of the base end 86 and the internal face of the cap end 88.

As perhaps best seen in FIG. 2A, the locking members 62 are transversally (radially) positioned between the housing walls 51 and the tumbler 64, and biased towards the tumbler 64 (and trigger path where the shaft is to be received) via biasing members 66 transversally positioned between the locking members 62 and the housing walls 51. In this particular embodiment, four locking members 62 are placed circumferentially around the tumbler 64 and circumferentially aligned with the transversal openings 82 of the tumbler 64 in such a manner for the tumbler links 74 to extend within gaps 94 between adjacent locking members 62 (as best seen in cross-sectional view of FIG. 2D). In this example, each one of the locking members 62 is biased by corresponding biasing members 66 that are aligned with and held in place by a corresponding housing wall 51.

Returning to FIG. 2B, the locking members 62 include an internal surface 96 facing the tumbler 64 which includes a base abutment 98 and a cap abutment 100 configured to transversally abut the base stop side 102 and the cap stop side 104 of the tumbler 64, respectively, when the tumbler 64 acts against the bias to keep the locking members away from the trigger path. The locking member 62 internal surface 96 further includes a base stop recess 106 and a cap stop recess 108 transversally defined within the internal surface 96, and configured to laterally receive at least part of the base stop 72 and the cap stop 70 of the tumbler 64, respectively. The base stop recess 106 and cap stop recess 108 being lengthwisely offset from the base abutment 98 and cap abutment 100 in the same direction and by the same distance. More specifically, in this example, the base stop recess 106 and cap stop recess 108 are lengthwisely adjacent to the base abutment 98 and cap abutment 100, respectively. The second locking feature 110 extends transversally from the internal surface 96 between the cap stop recess 108 and the base stop recess 106 of the locking members 62.

As will be further discussed below, the base abutment 98 and cap abutment 100 are transversally placed such that, when the tumbler 64 is placed in a manner for the base stop 72 to abut against the base abutment 98 and the cap stop 70 to abut against the cap abutment 100 (see also FIG. 3A), the second locking feature 110 is held away from the tumbler cavity 76, against the bias generated by the biasing member 66. This arrangement will be referred to here below as the snap joint 28 being in a disengaged position 118 (seen in FIGS. 3A and 3C). In contrast, the base stop recess 106 and cap stop recess 108 are transversally defined such that, when the tumbler 64 is placed in a manner for the base stop 72 and the cap stop 70 of the tumbler 64 to be engaged within the base stop recess 106 and cap stop recess 108, respectively (i.e. such as shown in FIG. 3B), the second locking feature 110 can extend through the transversal openings 82 of the tumbler 64 into the tumbler cavity 76. This arrangement will be referred to here below as the snap joint 28 being the engaged position 120 (seen in FIG. 3B).

Returning to FIG. 2A, the locking members 62 includes an external surface 114 facing the housing walls 51 which can be acted upon by the biasing members 66 in a manner to bias the locking member 62 towards the tumbler 64 and bias opposite locking members 62 towards one another. In this particular example, the external surface 114 is a uniform surface capable of receiving a plurality of springs 116 which collectively form a biasing member 66. It is understood that any other suitable external surface 114 profile can be used and that resilient members other than springs can be used as the biasing members 66 in alternate embodiments.

Reference will now be made to FIGS. 3A and 3B showing transversal cross-section views of the example snap joint 28 in a disengaged position 118, before engagement of the male member 34 with the female member 36, and in an engaged position 120, after engagement of the male member 34 with the female member 36, respectively.

Attention will first be made to FIG. 3A showing the snap joint 28 in a disengaged position 118. In this position, the base stop side 102 of the base stop 72 and the cap stop side 104 of the cap stop 70 abut against the base abutment 98 and cap abutment 100 of the locking members 62, respectively. The locking members 62 being transversally biased towards the tumbler 64 via the biasing members 66 and held in place by the abutment with the tumbler 64. The base stop 72 and cap stop 70 transversally holding the locking members 62 against the bias of the biasing member 66 and away from the tumbler cavity 76 such that the tumbler cavity 76 is free to receive the shaft 38 of the male member 34 as shown.

Still referring to FIG. 3A, when the modules are to be assembled, the shaft 38 of the male member 34 is inserted lengthwisely, along the trigger path 80, through the base end 56 aperture 68 of the housing 50 and through the tumbler aperture 78 of the base stop 72 such as to extend within the tumbler cavity 76. As the tumbler 64 holds the locking members 62 away from the tumbler cavity 76 in the disengaged position 118, the shaft 38 can be freely inserted or removed as required by the modular construction. The shaft 38 can be inserted along the trigger path 80 until its distal end 124 abuts against the inner surface 122 of the cap stop 70.

As perhaps best seen in FIG. 3B, when the shaft 38 is further pushed and inserted along the trigger path 80, the tumbler 64 is likewise longitudinally displaced 136 along the trigger path 80, while the locking members 62 are lengthwisely held in place by the base end 56 and cap end 58 of the housing 50. The base stop 72 and the cap stop 70 of the tumbler 64 are displaced congruously, sliding lengthwisely along and away from the base abutment 98 and cap abutment 100 of the locking members 62 towards the base stop recess 106 and cap stop recess 108, respectively.

As the base stop 72 and cap stop 70 simultaneously reach the axial positions of the base stop recess 106 and cap stop recess 108, respectively, the transversally (radially-inward) biased locking members 62 are released and transversally slide 138, along the internal surface of the base end 86 and the internal surface of the cap end 88 of the housing 50, towards the tumbler cavity 76. The base stop 72 and cap stop 70 of the tumbler 64 engaging with the base stop recess 106 and cap stop recess 108, respectively, permitting the second locking feature 110 to extend through the transversal opening 82 into the tumbler cavity 76 and into engagement with the first locking feature 40 of the shaft 38. At this point, the male member 34 is trapped within the female member 36 and the snap joint 28 is considered to be in the engaged position 120.

It will be appreciated that the combined tumbler 64 and locking members 62 structure described above permits the locking members 62 to be held parallel to one another in the disengaged position. That is, the cap abutment and the base abutment are held simultaneously by the cap stop and the base stop maintaining their orientation relative the axis, are released simultaneously from the cap stop and the base stop allowing them to move transversally rather than rotate, and the locking features of the locking member then engage the locking features of the shaft which again locks the orientation relative the axis. The locking members 62 are thus held parallel to one another both in the disengaged 118 and engaged position 120, while further capable of maintaining their parallelism throughout the locking procedure. As the base stop 72 and the cap stop 70 move congruously from the base abutment 98 and the cap abutment 100, respectively, the tumbler 64 releases the locking members 62 simultaneously, permitting the locking members 62 to transversally slide 138 towards the shaft 38 radially inwardly in a simultaneous and parallel fashion.

It will further be appreciated that the combined tumbler 64 and locking members 62 structure described above permits a certain amount of fool-proofness. As locking members 62 are lengthwisely trapped within the housing 50, while being held away from the tumbler cavity 76 by the tumbler 64, the male member 34 can be misaligned, and can even extend through a transversal opening 82 of the tumbler 64 and collide with a portion of a locking member 62, without risking accidentally displacing the tumbler 64 and placing the snap joint 28 in an engaged position 120 without the male member 34. This may permit a user to realign the module being assembled as required before fully inserting the male member 34, displacing 136 the tumbler 64 and locking the shaft 38 in place.

It will be understood that the force required to push and displace the tumbler 64 in the axial orientation (movement 136), such as to free the locking members 62, can be adjusted by increasing or decreasing the spring constant of the biasing member 66, such as to correspondingly adjusting the frictional forces to be overcome along the base abutment 98 and the cap abutment 100 during the sliding action of the tumbler 64 along the trigger path 80. It will be understood that other methods of adjusting the force required to displace the tumbler 64 can be used in alternate embodiments. For instance, adjusting the force required to displace 136 the tumbler 64 can be achieved by adjusting the materials of the shaft 38, of the locking members 62 or both. In yet another embodiment, the base abutment 98 or cap abutment 100 can be coated with a material permitting the modulate the frictional forces required to displace the tumbler 64 from the locking members abutments 98, 100.

Referring back to FIG. 3B, it will be noted that in the engaged position 120, the cap abutment is engaged across the transversal openings of the tumbler (e.g. between two adjacent links 74) like the locking feature 110 (crenellations). It will also be noted that the axial location of the base stop recess coincides with the thinnest portion of the locking member. Indeed, the base stop recess is formed within the thickness of the locking member and therefore limits the thickness of the locking member.

The specific embodiment presented in FIGS. 2A to 3E was found suitable in some embodiments, but was found to have some inconveniences in some other embodiments. More specifically, it was realized that the force transmission paths were as follows. Firstly, in compression, as schematized in FIG. 3E, the housing of the female member can abut directly against the frame of the male member, and thereby transfer forces directly. However, secondly, in tension, as schematized in FIG. 3D, force exerted on the module 30 is transferred to the male member, which transfers the force to the locking members via the locking features, and the locking members transfer the force to the housing of the female member. In this latter scenario, it was found that the incorporation of a base stop recess formed into the thickness of the locking members, and thereby forming a narrowest region of the thickness of the locking members, may lead to the material of the locking members yielding at that narrowest region, and that this failure may limit the amount of forces which the snap joint can sustain in tension. Indeed, tests have shown that the presence of the base stop recess 106 which is provided here in the form of a notch penetrating into the body of the locking members from the radially-inwardly facing face thereof, can lead to a failure mode where the yielding of the narrowest region tends to open up the spacing between the lower portions of the locking features.

It will also be noted that the portion of the axial length of the engagement members which is useable to incorporate locking features is limited by to the presence of the base stop recess. Indeed, of the total length Lt of the locking features (see FIG. 3A), only useful length Lu is useable to incorporate locking features, and in this embodiment, the useful length Lu represents less than 60% of the total length Lt. In one embodiment, it may be desired to address the failure mode caused by the base stop recess by providing an additional notch or slot in the radially outer face of the locking members, in a manner to balance out the effect of the base stop recess, or re-orient the orientation of the failure mode, potentially leading to a failure mode where the yielding of the narrower region would lead to a further compression between the locking features as opposed to an increase in the distance between the locking members. Such a solution may not be suitable to all embodiments, such as in embodiments where it is desired to limit the thickness of the locking members. In addressing such limitations, one may want to take several factors into consideration. First of all, the mechanical behavior of the snap joint in tension and compression must meet the requirements. There may also be a need to limit the volume/size of the snap joint, while also controlling costs. Moreover, the cap stops and base stops are to be free from the locking members, and the cap abutments and the base abutments are to be free of the tumbler when the tumbler is moved out from interference with the locking members, so as to allow the locking members to move radially inwardly and engage the male member. To this end, there can be a requirement for one form or another of cap stop and base stop recesses (free areas configured to accommodate the cap stops and the base stops when in the engaged configuration) and cap abutment and base abutment recesses (free areas configured to accommodate the cap abutments and the base abutments when in the engaged configuration).

FIGS. 4A-4H present an example of a second embodiment of a snap joint 210 which forms an alternative to the embodiment presented in FIGS. 2A to 3C (the latter hereinafter referred to as the first embodiment), and which can have some advantages over the first embodiment in some scenarios. While the second embodiment has many similarities to the first embodiment, it will be noted, in particular, that the locations of the cap stops, base stops, cap abutments, base abutments, cap stop recesses, base stop recesses, cap abutment recesses, and base abutment recesses are different. Let us begin by looking at the similarities.

The snap joint 210 presented in FIGS. 4A-4H has a female member 212 which operates on the basis of locking members 214 which are biased transversally (radially-inwardly) towards one another but held apart from one another by a tumbler 216 until the time of engagement with the male member 218. In this specific embodiment, two pairs of locking members 214 in an orthogonal configuration were used, though the number of pairs of locking members can vary in alternate embodiments as evoked above. Here, the locking members 214 also have generally planar bodies, of a generally rectangular shape. The plane associated to each one of the bodies of the locking members extends in axial and tangential orientations. The locking members 214 also have locking features on face which is directed radially-inwardly and which are configured to engage corresponding locking features of the male member. As can perhaps best be understood with reference to FIGS. 4C and 4G, the locking members 214 of a given pair are maintained spaced apart from one another, against the bias exerted by biasing members 232 (see FIG. 4D, can be provided here also in the form of one or more springs between the housing 222 and the locking members 214 for instance), by cap stops and base stops of the tumbler 216.

More specifically, the cap stops and the base stops of the tumbler 214 are engaged with cap abutments and base abutments of the locking members in the “armed” configuration (i.e. prior to the displacement of the tumbler by the male member). When the shaft of the male member 218 moves along the trigger path to fully penetrate the internal cavity between the locking members 214, such as in the movement between FIG. 4C and FIG. 4D, it eventually engages the cap 220 of the tumbler 214, and pushes the tumbler 214 in the axial orientation, towards the distal end of the housing 222. This frees the cap abutments from the cap stops, and the base abutments from the base stops, and therefore the resistance force exerted by the tumbler 216, allowing the locking members 214 of a given pair to move towards one another and engage the shaft of the male member 218 in the radial orientation, i.e. in a movement such as shown between FIGS. 4E and 4F, or between FIGS. 4G and 4H, ending in an “engaged” configuration.

Several details about the construction of the tumbler 216 and of the locking members 214 are different however in this second embodiment. The cap abutment and the base abutment are also spaced apart longitudinally (i.e. in the orientation of engagement of the male member, which can be referred to alternatively as “axially” in a cylindrical coordinate system where the axis coincides with the trigger path) from one another so as to maintain the axial orientation of the locking members 214 in the armed configuration, but are provided in the form of laterally-oriented protrusions to the generally planar body of the locking members 214 (as opposed to arcuate portions of the radially-internal face of the locking members). More specifically, in this embodiment, each cap abutment includes two tangentially opposite cap abutment portions 224 of a locking member 214 (on two opposite edges), and each base abutment includes two tangentially opposite base abutment portions 226 of the locking member 214 (also on two opposite sides).

The cap stops and the base stops are also embodied somewhat differently. There is no annular structure here at the distal end of the tumbler 216. Axially-oriented elongated members having an irregular shape along their length protrude axially from the cap 220 in the orientation of the aperture, and have free ends. In this embodiment, these elongated members can be referred to as prongs. The cap stop and the base stop in this embodiment are discontinuous. More specifically, a corresponding pair of prongs on opposite sides of a corresponding locking member 214 collaborate in providing the cap stop and base stop functionality. The cap stop associated to a given locking member 214 can be constituted of a cap stop portion 228 of a first prong, and a cap stop portion of a second prong. Similarly, the base stop associated to a given locking member can be constituted of a base stop portion 230 of the first prong, and of a base stop portion of the second prong. In this embodiment, each cap stop and each base stop includes a pair of stops, with one stop of each pair associated to each one of two prongs. Since the cap stops and the base stops are embodied as corresponding portions of different ones of the prongs, the cap stop and the base stop can be said to be discontinuous rather than continuous or annular. Cap stop recesses 234 and base stop recesses 236, which accommodate the cap stop and the base stop respectively in the engagement configuration, are provided in the form of narrower portions, which can be referred to as waists, of the lateral edges of the locking members 214, axially adjacent the cap abutment and base abutment. Cap abutment recesses 238, accommodating the cap abutment in the engagement configuration, are defined by a waist provided along a length of the prongs, between the longitudinal positions of the cap stop and of the base stop. A base abutment recess 240 is provided in the form of a free space adjacent a free end of the prong.

Accordingly, when the female member 212 is in the armed configuration, shown in FIGS. 4A, 4C, 4E and 4G, the tumbler 216 is at an armed position, defined axially relative the housing 222. In the armed position, the bias forces the locking members 214 towards one another, but the tumbler 216 generates an opposing force. More specifically, the cap abutments are engaged with the cap stops, and the base abutments are engaged with the base stops. The axial distance between the cap stops and the base stops are configured to maintain the parallelism of the locking members 214. From the armed configuration, the female member 212 can be switched to the engaged configuration (FIGS. 4B, 4D, 4F, 4H) by moving the tumbler 216 in the axial orientation, from the armed position to the engaged position, axially towards the distal end.

The axial distance between the base abutment recess and the cap abutment recess is the same than the axial distance between the cap stop and the base stop, and therefore, when the tumbler 216 is moved to the engagement position, the cap abutments and the base abutments become simultaneously disengaged from the cap stops and base stops, and aligned with the cap abutment recess and the base abutment recess, allowing a radially-oriented movement of the axially elongated locking members 214 which maintains the parallelism during the engagement, until the locking members 214 become engaged with the male member 218, which then also maintains the parallelism. This is perhaps best seen with reference to FIGS. 4J and 4K where in FIG. 4J, the tangential protrusions embodying the cap abutment and the base abutment on the left hand side are shown to be maintained in an axial orientation by their abutment against the cap stop and the base stop on the right hand side.

Upon axial movement of the tumbler 216, eventually the cap abutment and the base abutment are freed from the cap stop and base stop simultaneously, freeing them to move radially inwardly. At this stage, the cap abutment can be received in a cap abutment recess formed as a waist portion between two broader portions of the prongs, with the latter broader portions embodying the cap stop and base stop respectively. A variant is presented in FIGS. 4L and 4M where a radial offset is provided between the cap abutment and the base abutment, and the narrower portion of the prongs simply continue axially from the cap stop to the free end, to form successively the cap abutment recess and the base stop. This variant can work as well as shown in FIG. 4M where the base abutment is simply received below the free end of the prong, and it is the free space adjacent the free end of the prongs which form the base abutment recess which receives the base abutments. In still another variant, rather than being integrated to the prongs, the cap stop can be provided as a portion of the cap itself, and the cap abutment can be provided in the form of an arcuate portion of the radially-inwardly facing surface of the locking member. Many further variations are possible.

Except for the tangential protrusions forming the cap abutments and the base abutments, the bodies of the locking member can be narrower than a spacing between the broader portions of corresponding pairs of prongs, allowing those portions of the bodies to move freely across the spacing when they are not refrained by the action of the abutments and stops. The tangential protrusions can be broader than a tangential spacing between the broader portions of corresponding pairs of prongs, so as to engage with the broader portions of the corresponding pairs of prongs when axially aligned with them, while remaining narrower that a tangential spacing between waist portions of the corresponding pairs of prongs, allowing the protrusions to move into the recesses when the become axially aligned with the recesses.

Although the construction of the second embodiment has several differences with the construction presented the first embodiment, the mode of operation can retain several similarities. Indeed, in this embodiment as well, there can be a single pair of locking members, or two pairs of locking members orthogonal to one another, for instance. In this embodiment as well, a trigger path can be said to extend through the base stop, or more precisely through a virtual periphery 242 (schematized at FIGS. 4E and 4F) formed by a closed shape connecting each one of the prongs discontinuously forming the base stops and cap stops. The trigger path can extend through the base stop, and through the cap stop, and ultimately to the cap. Accordingly, the male member can proceed along the trigger path when engaging with the female member, and a tip thereof can proceed through the virtual periphery associated to the base stop, to and through the cap stop, and ultimately engage the cap, onto which it can exert a force which can move the tumbler. The base stop and the cap stop which form part of the tumbler move with it longitudinally from a position of engagement with the cap abutment and the base abutment to a position of disengagement from the cap abutment and the base abutment. In the position of disengagement, the cap abutment and the base abutment are freed from the tumbler and rather aligned with the cap opening and the base opening, at which point the bias moves one, or both locking members towards the other, engaging the locking features of the locking members with the locking features of the male member. However, at this point, the cap abutment is moved into the cap opening and the base abutment is moved into the base opening as opposed to the embodiment presented in the US publication cap where the cap opening was moved onto the cap stop and the base opening which was moved onto the base stop in. At the latter point, the engagement between the locking features of the male member and the locking features of the female member generates a reactive opposing force to an eventual force which would act to retract the male member from the female member.

A significant distinction associated to the mode of operation can be understood when considering the force paths when the snap joints are in operation. The force path of the first embodiment is presented at FIG. 3F for tension, and presented at 3G for compression. As can be understood, in some scenarios, the force path can extend within the locking members themselves, which may be weakened by the incorporation of a base stop recess. In the second embodiment, the base stop recesses are provided axially between the protrusions embodying the cap abutments and the base abutments, in the corner gaps of the housing between locking members, and therefore no longer “interfere” with the force paths (see FIGS. 4J and 4K). Another difference is that in some embodiments, by using a configuration such as in the second embodiment, a greater proportion of the axial length of the locking members can be used to provide locking features. In the example embodiment, the proportion of axial length having locking features Lu can be of more than 85% of the total length Lt, as represented in FIG. 4B.

It will be noted here that the exact profile of the locking features can vary significantly from one embodiment to another, with the depth of the grooves in the second embodiment, provided as an example, being significantly smaller than the thickness of the ribs or grooves (e.g. less than 50%), as represented in FIG. 41. It will also be noted that in this embodiment, the base abutment recesses are provided at the distal ends of the prongs, but it will be understood with reference to FIGS. 4J and 4K that prolonging the prongs with narrow portions similar to the size of the waists would not interfere with the base abutment recess function of accomodating the base abutment in the engaged configuration.

While the snap joints may be intended to remain in the engaged configuration throughout the useful life of the modular building, in some embodiments, it may nonetheless be desired for the snap joints to have a disengagement ability, which would allow the snap joint to be manually disengaged, without having to demolish any of the surrounding structure. This can be useful in scenarios such as, say, if the construction module having the snap joint is engaged with the wrong other construction module by error.

Returning to FIG. 2A, the housing walls 51 include disengagement apertures 126 in order to permit reverting the snap joint 28 to the disengaged position 120 after being engaged. In this particular example, a disengagement aperture 126 is defined in each one of the housing walls 51 and a threaded bore 128 is included within the locking members 62. The threaded bore 128 is aligned and accessible from the disengagement aperture 126. As perhaps best seen in FIG. 3C, showing a side sectional view of the exemplary snap joint 28 having been returned to a disengaged position 118, fasteners 132 have been used as a disengagement tool 130 for sliding the locking members 62 away from the male member 34 and reverting the snap joint 28 to a disengaged position 118. The fasteners 132 have been inserted through the disengagement aperture 126 and threaded into the threaded bore 128 of the locking member 62. As the fastener 132 is rotated, the fastener 132 thread engages with the threaded bore 128 and generates a pulling force, such as to transversally slide the locking members 62 against the bias and away from the tumbler cavity 76. In this embodiment, the location of the threaded bore 128, disengagement aperture 126, can coincide with a center of the generally rectangular body of the locking member, to allow the pulling force exerted by the fastener 132 to be shared roughly equally amongst the plurality of springs. The sliding of the locking members 62 effectively retreats the second locking feature 110 from the first locking feature 40 and disengages the male member 34 which can be freely removed 134 from the tumbler cavity 76 along the trigger path 80.

As the locking members 62 are pulled away from the tumbler cavity 76, the base stop 72 and the cap stop 70 are disengaged from the base stop recess 106 and the cap stop recess 108. At this point, the tumbler is free to move downwardly under the effect of gravity, along the trigger path 80 into the armed position 118, at which point the fastener 132 can be removed, allowing the biasing force to move the locking members back into engagement with the tumbler, with the base stop 102 abutting against the base abutment 98 and the cap stop 104 abutting against the cap abutment 100, respectively, i.e. into the armed configuration. The snap joint 28 may then once again be used for assembly of modules by receiving the male member 34 as described above with reference to FIGS. 3A and 3B. Such a disengagement functionality is optional.

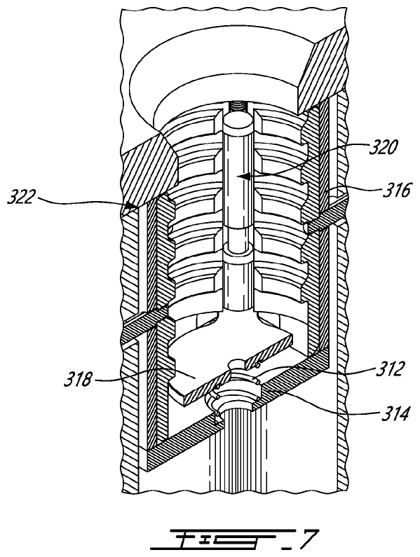

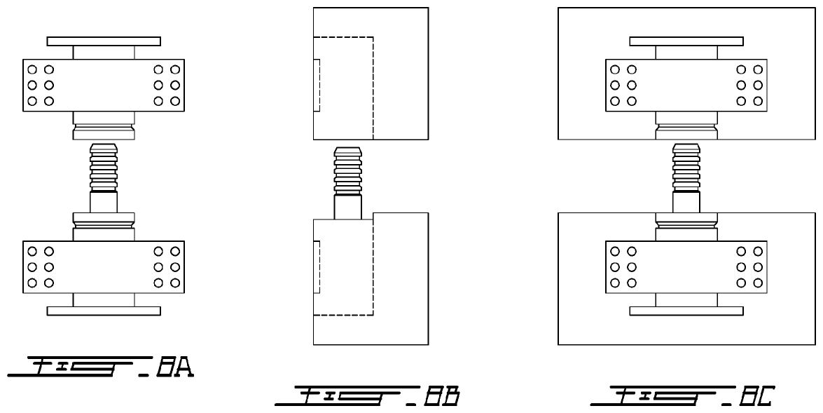

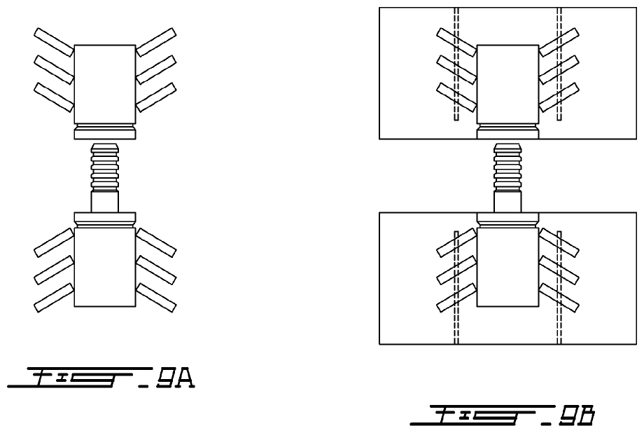

In embodiments where the aperture of the female member is directed downwardly (i.e. the female member is assembled to a construction module in a manner that its aperture will be directed downwardly, and the shaft engage it upwardly, when installed in a design configuration), gravity may be used as a biasing force to bias the tumbler downwardly when the shaft is not pushing it upwardly or holding it in a raised, engaged position. This biasing force can be useful for various reasons, one of which is the ability to return the tumbler back to the armed position automatically in the event where the female member needs to be disengaged from the male member. In embodiments where this function exerted by gravity is deemed useful, one may restrict the use of female members to the downward facing direction (e.g. as schematized at FIG. 5A) which may be inconvenient in some embodiments.

For instance, some embodiments may benefit from using female members in laterally facing directions (e.g. such as schematized in FIG. 5B). This may be the case in scenarios where female members are configured to be secured to a first construction module, a male member is configured to be secured to a second construction module, and the male member becomes snappingly engaged with the female member upon assembly of the first construction module to the second construction module in the lateral orientation. Some embodiments may benefit from using a female member in an upwardly facing direction, such as schematized in FIG. 5C. Both the embodiments schematized in FIG. 5B and in FIG. 5C do not benefit from gravity in the way the embodiment schematized in FIG. 5A may benefit.

Moreover, in some other embodiments, the latter type of scenario (e. g as illustrated in FIG. 4C or 2A) may be deemed inconvenient. Indeed, the shaft of the male member may protrude from an otherwise planar surface of the construction module to which it is assembled in some embodiments (see FIG. 2A for instance), which may be considered inconvenient in some situations, such as some transport or handling scenarios.

One way to address the latter inconvenience is to use, rather than a female member secured to a first construction module and a male member secured to a second construction module, a first female member secured to a first construction module, a second female member secured to a second construction module, and a male member in the form of a double-ended shaft which can be kept separately during transport, and used as a link between the two female members at the construction site, upon assembly. An example of a male member having a double-ended shaft is presented in FIG. 6. The female members used in conjunction with such a doubled-ended shaft male member may be of any suitable configuration, including all configurations presented in this specification. It may be desired to use such a configuration in a vertical type configuration such as FIG. 5D, or in a horizontal type configuration such as schematized in FIG. 5E, depending on the embodiment. It will be noted that the upward-facing female member in the scenario of FIG. 5D, and both female members of the scenario presented in FIG. 5E, do not benefit from gravity in the same way as the downward-facing female member of scenarios 5A or 5D do and in particular, in the upward-directed scenarios of FIGS. 5C and 5D, gravity may not only not act usefully, but may rather act in the opposite direction.

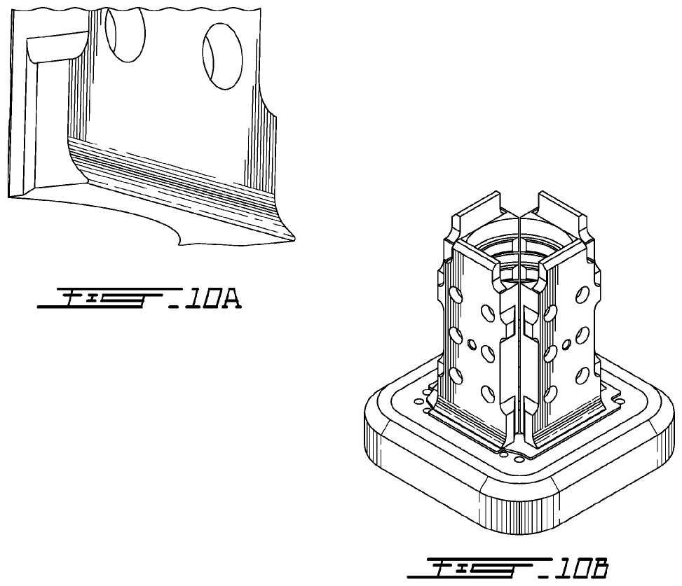

It was found however that in some embodiments, it was possible to provide similar benefits to what gravity could otherwise offer, or even to strengthen the bias which would normally be provided by gravity, by introducing an optional biasing member 312 between the distal end 314 of the housing 316 and the cap 318 of the tumbler 320. An example of such a biasing member 312 is presented in FIG. 7.

FIG. 7 presents an example case having a construction similar to the construction presented in FIG. 4B or 4G, but where the female member 322 is used in an opposite direction, i.e. with the aperture facing upwardly. Accordingly, gravity acts on the tumbler 320 here in the direction of moving the tumbler 320 towards the distal end 314 of the housing 322, rather than away from the distal end 314 of the housing. In the specific embodiment of FIG. 7, this is compensated by a biasing member 312 provided here in the form of a spring which is seated in a socket provided in the distal end 314 of the housing 322 and in the distal face of the cap 318, and which exerts a force in accordance with its spring constant and its displacement. This force can be tuned so as to bias the tumbler 320 to the armed position in the absence of an external force such as may be exerted by a shaft (single or double-ended) of a male member. Such a biasing member 312 can be used in various use cases, including in a female member which is used in the downward facing orientation (e.g. FIG. 5A or upper portion of FIG. 5D), but may be particularly useful in upward facing orientations (e.g. FIG. 5C or lower portion of FIG. 5D) or lateral-facing orientations (e.g. FIG. 5B or FIG. 5E).

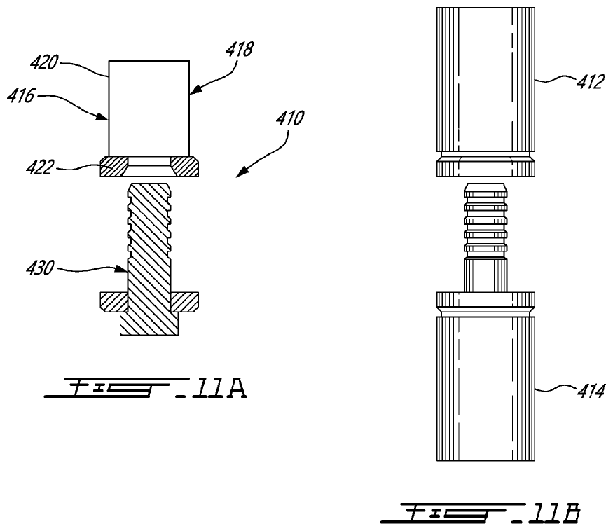

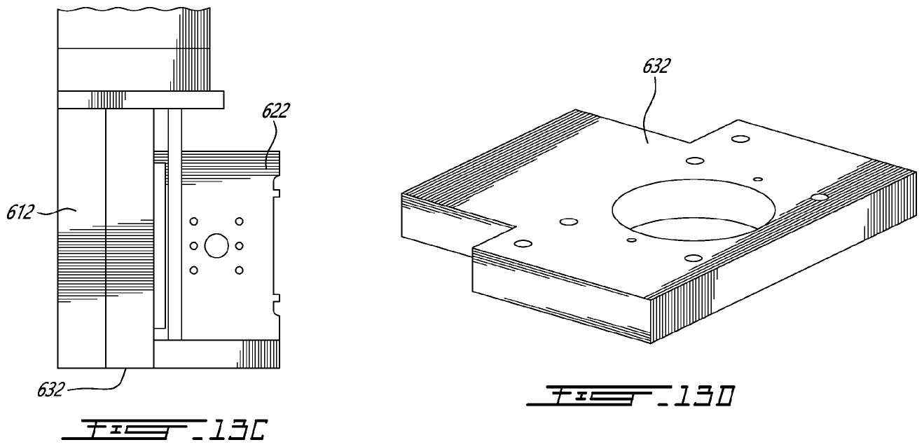

There are various use cases to which snap joint embodiments, such as those presented herein or others, can be adapted. In one example use case, a snap joint can be integrated to a structure of mass timber, such as presented in FIGS. 8A, 8B and 8C. More specifically, mass timber products are typically embodied as solid, structural load-bearing components such as columns, beams, and panels. They are typically manufactured off-site in factories by fastening multiple layers of wood together with glue, dowels and/or nails, and are engineered for high strength. In one example scenario, a snap joint having a female member and a male member, or two female members and a double-ended-shaft-type male member, can be integrated into a structure beam of a mass timber product. In this embodiment, the housings of the female members or female and male members can be provided with a fixation plate on one of their faces (e.g. by fastening, soldering, or any other suitable means). A cavity shaped to tightly receive the housing and the fixation plate can be defined in the solid mass of timber. The fixation plate can be designed to protrude laterally from the housing and to be exposed on an outer face of the mass timber structure when the housing has been introduced into the cavity, at which point fasteners or an adhesive can be used to secure the fixation plate to the mass timber structure, for instance. Additional protrusions can be provided externally to the housing which may be useful, depending on the embodiments, to address any moments which could result in the assembly in addition to compression or tension forces. The housings can be as presented in FIG. 3A or 4A for instance, to which a fixation plate may either be secured to the housing or provided integrally to the housing. It will be noted that the housing can have a single layer or multiple layers depending on the embodiment. In particular, in some embodiments, it can be deemed suitable to provide the housing with an internal cage structure such as shown in FIG. 12A, which can be provided with features configured for receiving the locking members, tumbler, and any biasing member used, and to introduce this internal cage structure into a structural external housing such as a length of a hollow steel beam which is used in the specific example of FIG. 12A. In such a case, it can be the external housing rather than the internal cage structure which bears the fixation plate and any additional protrusions such as additional plates configured to exchange forces or moments with the mass timber structure. In some other embodiments, the cage structure may be inherently structural and used to directly receive the fixation plate and any additional protrusions.

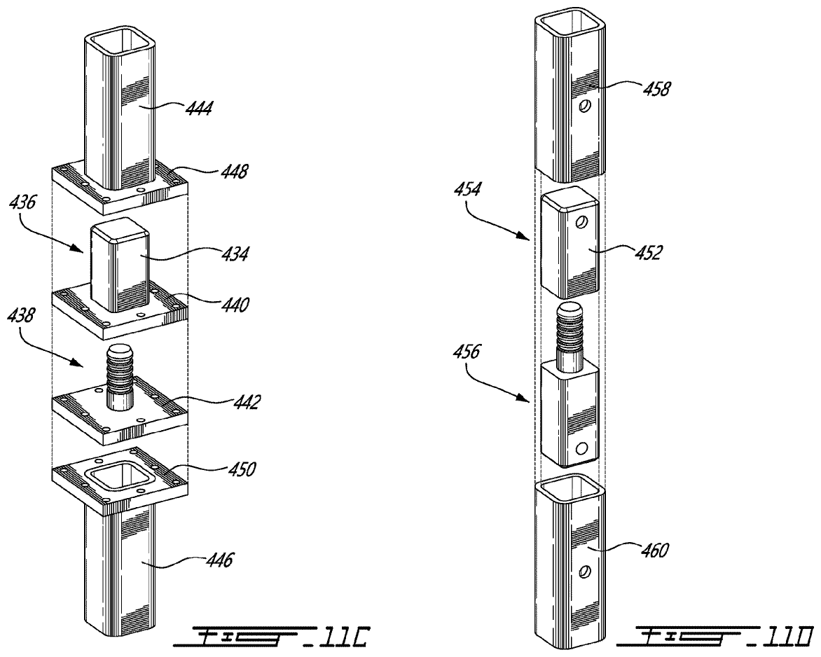

In another example use case, a snap joint can be integrated to a structure of concrete such as steel-reinforced concrete or other types of concrete, such as presented in FIG. 9A or 9B. In one example scenario, a snap joint having a female member and a male member, or two female members and a double-ended-shaft-type male member, can be integrated into a concrete structure. For instance, the housing of the female or male member can be provided with integrated irregularities or protuberances such as fins, ribs, etc, so as to provide a strong interface with the concrete for the transfer of forces. At the time of casting the concrete, the housings can be laid into the formwork together with any rebar or other auxiliary elements such as an eventual supporting structure for the housings, and the concrete can be cast to as to fill area around the housing and the interstices between the irregularities or protuberances and any rebar reinforcement or support. In this embodiment, the housings of the female members or female and male members can be provided irregularities or protuberances by any suitable means such as fastening, soldering, or forming integrally to the housing (e.g. casting, additive manufacturing, machining). Apart from the irregularities or protuberances, the housings can be generally as presented in FIG. 3A or 4A for instance. It will be noted that the housing can have a single layer or multiple layers depending on the embodiment. In particular, in some embodiments, it can be deemed suitable to provide the housing with an internal cage structure such as shown in FIG. 12A, which can be provided with features configured for receiving the locking members, tumbler, and any biasing member used, and to introduce this internal cage structure into a structural external housing such as a length of a hollow steel beam which is used in the specific example of FIG. 12A. In such a case, it can be the external housing rather than the internal cage structure which bears the protrusions which are configured to exchange forces or moments with the concrete structure or with a supporting structure at the time of casting for instance. In some other embodiments, the cage structure may be inherently structural and used to directly receive the protrusions and/or supporting structure. It will be understood that the concrete can be cast at a production plant to form a module which is carried to the construction site, or cast directly at the construction site for example. In particular, it may be relevant in some embodiments to integrate a male or female member of a snap joint directly into a concrete foundation of a building to ready it to receive a module which bears a mating male or female member.

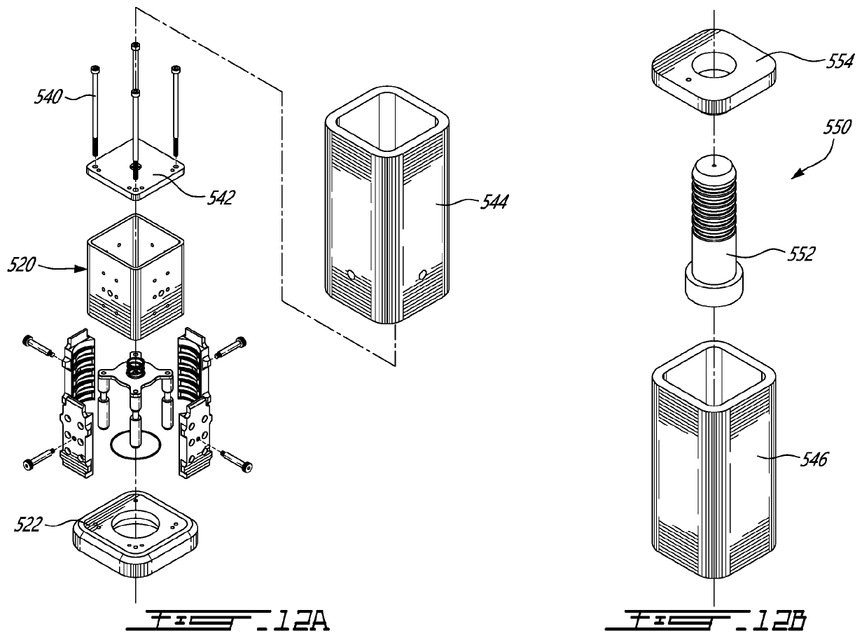

Depending on the embodiment, the proximal end of the locking members can be engaged directly against the support plate (e.g. onto an internally-oriented ledge), or onto another component. In particular, it can be desired for the material of the locking members to be made of a harder type of steel than the material used for the support plate, and if the force path, either in tension or in compression, passes through the interface between the locking member and the support plate directly, the locking member may dent, imprint, or otherwise wear the material of the support plate, which may be undesired. In particular, this can be the case when, such as in the embodiment illustrated in FIG. 12A the housing includes an internal cage structure and a structural external housing. More specifically, such a construction can involve, at the proximal end, a support plate to which the cage structure is made integral to (e.g. assembled or integrally manufactured), which includes an external ledge which is configured to receive the external housing structure. For instance, the support plate may be secured to the external housing by welding or fastening (e.g., by bolting or screwing). In the event of a weld, the weld may be made between the external ledge and the external housing, for instance. Such a support plate can also have an internal ledge configured to receive the proximal ends of the locking members, and if the support plate is made of a material configured to be welded to an external housing structure, it may be made of a material which is softer than the material of the locking members, particularly in such an embodiment where the internal space available for the locking members may be limited. In particular, even in compression, a force path may pass by the interface between the proximal ends of the locking members and the support plate as it may be difficult to reduce the gap between the male member and the female member sufficiently to avoid this. In one embodiment, it is possible to alleviate this phenomena by using a locking member geometry which has a broadening feature or foot at its lower end, an example of which is presented in FIG. 10A. In another embodiment, this can be alleviated by abutting the proximal ends of the locking members against an other, harder, component than the support plate, such as a corresponding portion of the cage structure (e.g. internally oriented proximal end ledge of cage structure), or some form of gasket or protective intermediate material. FIG. 10B presents an embodiment where the locking member interfaces with the support plate via an intermediary gasket material which is broader than the proximal ends of the locking members and which is harder than the material of the support plate as an example. In one embodiment, the locking members can be made of 1144 steel, the intermediary protective material or gasket can be made of spring steel, and thus be the hardest material, and the support plate can be made of ordinary construction steel such as A-36, 350W, etc. In still another example embodiment, the support plate may be secured to the external housing by fastening, the support plate may be made of a same material as the locking members, and the locking members may be directly engaged against the support plate, such as without an intermediate material, and may not have broadened features or foot at the lower end.

In another example use case, a snap joint 410 can be integrated to a construction module having a steel structure, and more specifically to elements 412, 414 of such of a structure having a hollow section. Such elements 412, 414 can be a hollow structural section (HSS) elements for instance. The profile (cross-sectional shape) of such a hollow section can be square, rectangular, circular, and other shapes are possible. Such elements are known to have a good resistance to torsion in particular. The term HSS is used predominantly in the United States where HSS elements are made of steel by code.

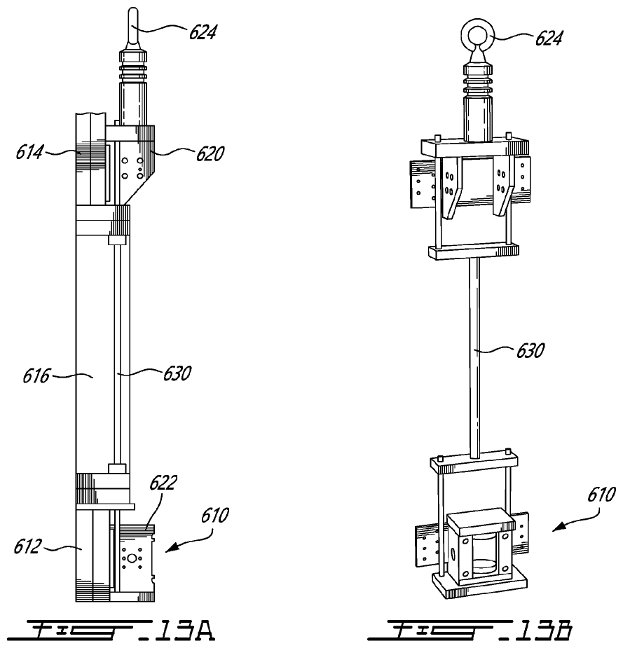

In such use cases, and such as schematized in FIGS. 11A and 11B, it can be relevant to manufacture the snap joint 410 as a component which is initially separate from the hollow section elements 412, 414 to which they are to be assembled. In the case of female members 416, which can be more complex due to the presence of the tumbler and of the locking members for instance, it was found convenient in some use cases to use a housing 418 which was made of two distinct components. Namely, a cage structure 420 and a support plate 422. The cage structure 420 can be the portion of the housing 418 which is used to house the locking members and the tumbler therein, whereas the support plate 422 can be used as a structural link or interface to the end of the hollow section 412, to which it can be soldered or fastened for instance. To facilitate soldering, it can be preferred to use a softer type of steel for the support plate 422 than other structural elements of the snap joint such as the locking members in particular. The support plate 422 can bear the aperture through which the male member 430 is engaged. The cage 420 can be secured to the support plate 422 in any suitable manner, such as welding, fastening, or producing integrally such as via machining, casting or additive manufacturing for instance. The cage structure 420 can be sized as a function of the size of the cavity in the hollow profile, so as to be insertable into the hollow profile via an open end thereof. The support plate 422 can form an external ledge protruding from the cage 420 away from the axis, and configured to come into abutment with the end of the hollow profile once the cage structure 420 has become fully engaged, where it can be secured into place such as schematized in FIG. 11B. In such situations, the support plate may be welded to an HSS element which also forms an external housing, or fastened to such an HSS element, to name two examples.

In the specific embodiment presented in FIG. 11B, it will be understood that the cage structure 420 has been introduced, via an open end of the HSS steel structural beam, into the hollow center of the HSS steel structural beam. In this position, the housing, and more specifically the support plate 422, may be soldered to the periphery of the HSS steel structural beam. The male member 430 can be introduced into and soldered against the periphery of the HSS steel structural beam in a similar manner. While this soldering approach may be convenient in some embodiments, it may not be convenient in others. Indeed, the soldering process may produce heat which may prevent, for example, the use of plastic components in the cage structure where such plastic components may otherwise have been preferred. The soldering process may also be relatively difficult to undo, and it may be preferred for the securing of the housing to the HSS element to be undoable more easily than by undoing a solder. Accordingly, in some embodiments, it may be preferred to fasten the housing of the female member to the HSS element rather than to solder them to one another.

FIG. 11C presents an example embodiment where the housing 434 of the female member 436, and the male member 438, both have a support plate with a transversally extending edge 440, 442. Similarly, a first HSS element 444 and a second HSS element 446 are both provided with support plates with transversally extending edges 448, 450. The transversally extending edges are apertured, such that a first set of fasteners (not shown) may be used to secure the transversally extending edge 444 the housing to the transversally extending edge 448 of the first HSS element, and a second set of fasteners (not shown) may be used to secure the transversally extending edge 442 of the male member to the transversally extending edge 450 of the second HSS element.

It will be noted that in other embodiments, a transversally extending edge may be integral to a cage structure other than by being provided on a support plate secured to the cage structure, such as by being manufactured integrally thereto (e.g. casting, additive manufacturing, etc.).

FIG. 11D presents another example embodiment where the housing 452 of the female member 454 and the male member 456 are fastenable to a first HSS element 458 and to a second HSS element 460, respectively. More specifically, an aperture is formed transversally through the housing 452 of the female member 454, such as through the cage structure, and an aperture is formed transversally across the first HSS element 458 such that, when the cage structure is introduced into the first HSS element 458, the apertures may be aligned and a fastener may be driven through the apertures to maintain the axial alignment between these two components thereafter. In the embodiment presented in FIG. 11D, the male member 456 an be secured to the second HSS element 460 in a manner similar to the way the female member 454 is secured to the first HSS element 458, i.e., with a transversally introduced fastener.

In an example embodiment such as presented in FIG. 12A, the cage structure 520 can be fastened to the support plate 522 via elongated bolts 540 having heads engaged with the distal end 542 of the cage structure 520 and threaded tips engaged with threaded bores defined in the distal face of the support plate 522. The hollow structural section element 544 can form part of the structure of the construction module itself or form an external housing which is configured to be assembled (e.g. welded) to a construction module, the latter option being used in the illustrated embodiment.

Referring to FIG. 12B, a male member 550 can be integrated to the hollow structural element 546 in a similar manner. A shaft 552 can be manufactured separately from a support plate 554. The shaft 552 can have a head opposite a tip. The support plate 554 can have an aperture for receiving a stem of the shaft 552. The head of the shaft can be soldered or fastened to the distal face of the support plate 554, and the external ledge of the support plate 554 can be placed into abutment with the end of the hollow structural beam 546, with the head of the shaft engaged in the cavity, where the support plate 554 can be secured (e.g., soldered or fastened) to the hollow support beam 546 to complete the assembly. The hollow structural section element 546 can form part of the structure of the construction module itself, or forme an external housing which is configured to be assembled (e.g. welded) to a construction module, the latter option being used in the illustrated embodiment.

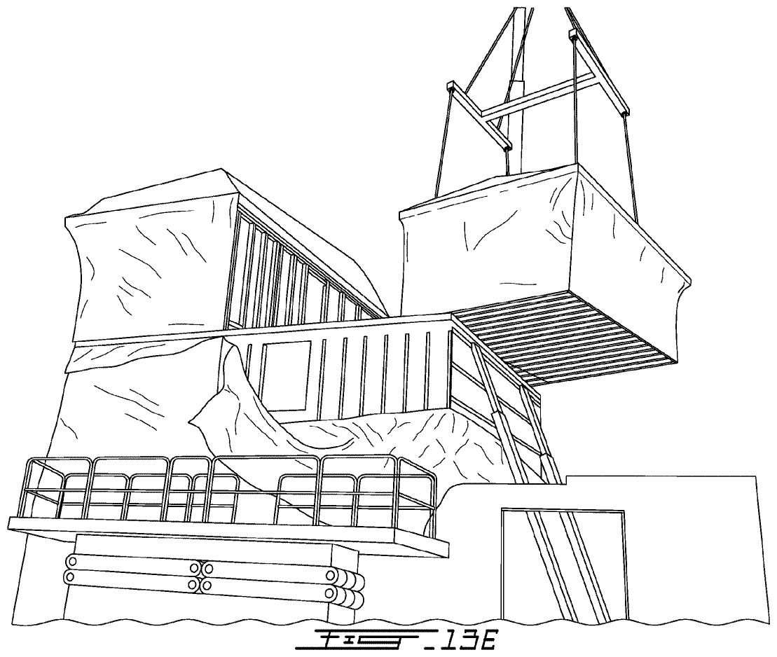

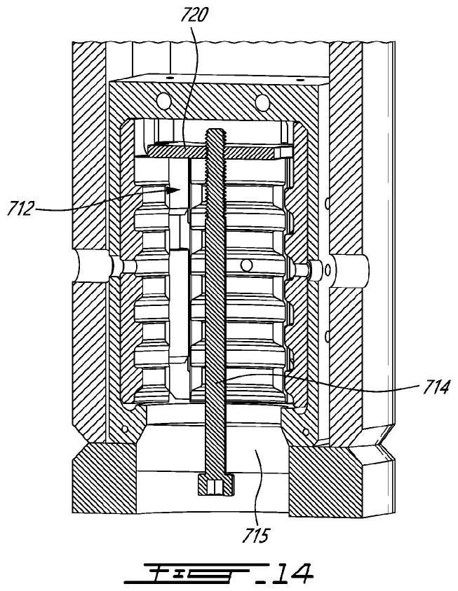

Referring to FIGS. 13A to 13E, in another example use case, a snap joint 610 can be integrated to a construction module having a structure of dimensional lumber, sometimes referred to as a lightweight structure. The module can have a generally rectangular parallelepiped shaped frame made of an assembly of dimensional lumber boards and including a lower periphery 612 secured to an upper periphery 614 via a plurality of studs 616. The upper periphery 614 can be made of a periphery of ceiling rim boards and a periphery of top plate boards for instance, whereas the lower periphery 612 can be made of a periphery of floor rim boards and of bottom plate boards for instance, to which OSB sheeting or other sub-flooring may be integrated. A first member 620 of the snap joint 610 is secured to the upper periphery 614, whereas a second member 622 of the snap joint structure 610 is secured to the lower periphery. Either one of the first member 620 and of the second member 622 may be a male member or a female member (i.e. either one can be male, the other female, or both female with a separate male-male coupler being provided), and both have some form of structure which will be referred to as a housing. Some form of lifting means may be provided for to couple a lifting rigging to the first member 620 (more typically to a plurality of first members provided at different locations along the upper periphery).

In the specific example presented in FIGS. 13A to 13D, the first member 620 is a male member provided with a threaded bore in its shaft, and a coupler in the form of an eye-nut 624 has a threaded stem engaged with the threaded bore of the shaft, to which lifting rigging can be attached (various alternatives may be used in alternate embodiments), for assembling the module such as presented in FIG. 13E. However, such modules may be structurally adapted to be lifted from underneath rather than pulled from above. To this end, a structure can be adapted to convert the lifting force exerted on the first member 620 to a lifting force exerted underneath the lower periphery 612. Indeed, a structural member 630, such as a structural prong or metal prong, chain or cable, can be used to secure the housing of the first member 620 to the housing of the second member 622 to transfer the lifting force to the second member 622. Moreover, the housing of the second member 622 can be provided with an extension plate 632, best seen in FIGS. 15C and 15D, which can extend underneath the rim board (or, as in this example, engage a notch formed in the rim board so as to avoid protruding therefrom). Accordingly, a lifting force exerted at the first member 620 can be converted to a lifting force exerted under the lower periphery 612.

In an alternate embodiment the first member of the snap joint can be mounted to an upper opening in a hollow structural beam, the second member of the snap joint can be mounted to a lower opening in the hollow structural beam, in which case its external ledge can act as a plate extension supporting the construction module from below, the hollow structural beam itself can act as a link structurally connecting the first member to the second member, and the construction module can be raised via the first member similarly to the scenario presented above in relation with a dimensional lumber construction.

It will be noted that in embodiments where female members are assembled to the modules at a factory and transported to a construction site, there can be a greater risk that foreign matter may be introduced into the cavity through the aperture during transport or handling, leading to a risk of malfunction at the construction site and/or premature disengagement of the tumbler and movement of the locking members. It was found that many such inconveniences could be avoided by installing, at the time of assembly, a spigot 715 to block the aperture during transport and handling, and to remove this spigot 715 only at the time of installation. To this end, the cap 720 of the tumbler 712 can be provided with a threaded bore, and a retaining member having a stem 714 secured to the spigot 715 (e.g. via a head externally engaged with the spigot) and a tip threadingly engaged with the threaded bore of the cap 720 may be very convenient. Alternately, for instance, a hole can be provided in the cap and the threaded bore can be provided in the distal end of the housing, with the step extending through the hole and into the threaded bore.

As can be understood, the examples described above and illustrated are intended to be exemplary only.

For instance, in the above examples, the male member shaft has a generally circular cross-section, and the components within the female member have features with a corresponding shape in order to properly interface with the male member. It will be understood that the male member and/or the corresponding components of the female member can be adjusted to other shapes without departing from the present disclosure. For instance, in an alternate embodiment, the shaft can have a generally rectangular cross-section. Similarly, the female member can have a rectangular aperture in the base end, and/or a tumbler with a rectangular base stop, a rectangular cap stop as well as a rectangular tumbler aperture. In this alternate embodiment, the locking members have a generally flat second locking feature corresponding to the profile of the external face of the shaft. It will thus be understood that various shapes and arrangements can be used without departing from the present disclosure and that the use of cylindrical coordinates to describe a given embodiment does not imply a cylindrical geometry of any one of the components unless specifically mentioned.

While the above examples show locking members with both a cap abutment, a cap stop recess, a base abutment and a base stop recess, it will be understood that the location or relative position of one or many of these features can be altered in alternate embodiments. For instance, the locking members can omit having a cap stop recess and the snap joint can instead include a cap stop socket defined in the internal surface of the cap end of the housing. The cap stop socket being lengthwisely aligned with the cap stop of the tumbler. In this example, when the tumbler is displaced along the trigger path, the cap stop slides lengthwisely into the cap stop socket, such as to disengage with the cap abutment and allow the cap surface of the locking member to transversally slide along the internal face of the cap end of the housing, towards the tumbler cavity and into engagement with the inserted male member. In yet another embodiment, the relative distance between the cap/base abutment and the cap/base stop recess can be increased or decreased in order to modulate the amount travel of the tumbler along the trigger path required before the release of the locking members.

While the above examples show a snap joint wherein various of the locking members transversally slide within the housing toward the tumbler, it will be understood that in alternate embodiments, at least one of the locking members is made integral to or permanently mounted to the housing. For instance, in an alternate embodiment, a female member containing two locking members circumferentially placed around the tumbler and opposed to one another can contain a first locking member made integral to the housing, while the second locking member is biased towards the first locking member. The tumbler holding the second locking member against the bias as described above. When in the engaged position, second locking member engaging with the shaft and biasing the shaft towards the first locking member, such as to engage the shaft with second locking feature of both the first and second locking members.

While the snap joint has been presented above as being applied to the field of modular constructions, it will be understood that the snap joint concept presented herein can also be applied to alternate applications, such as furniture assembly, the fixation of outer cladding on buildings, the assembly of temporary event structures and/or in the general field of delivery, for instance, where an increase number of modular solutions are being sought in order to gain in delivery efficiency. The snap joint is further applicable to the field of clothing, particularly sports clothing, in which a quick and secure connection is often sought.

Moreover, it will be understood that while the example female members presented herein have a mechanism operating on the basis of locking members biased transversally inwardly toward the engagement axis, held against the bias in the armed position via a tumbler, and togglable from the armed configuration to an engaged configuration by the movement of the shaft against the tumbler, other embodiments may have different forms of mechanisms, such as mechanisms which operate on the basis of the pivoting of components rather than the transversal sliding of locking members for instance.

The scope is indicated by the appended claims.

1. A female member of a snap joint for securing a first construction module to a second construction module on a modular construction site, the female member comprising:
a housing having a cage structure having a proximal end opposite a distal end relative an engagement axis, having an open periphery at the proximal end, and configured to receive a shaft of a male member of the snap joint into the cage structure along the engagement axis; configured for securing to a periphery of a hollow structural section (HSS) steel structural beam when the cage structure is positioned inside the HSS steel structural beam; and
a pair of locking members inside the cage structure and biased towards one another, the locking members opposing the bias when at an armed configuration, and disengaged from the armed configuration to an engagement configuration, in which engagement configuration the bias can move the locking members towards one another and into engagement with the male member.

2. The female member of claim 1, wherein the cage has the open periphery, the housing further has a support plate secured to the proximal end of the cage structure, the support plate having an aperture formed therein and configured to receive the shaft, the support plate having an external ledge protruding from the cage structure away from the axis, the external ledge being configured for securing to the periphery of the HSS steel structural beam when the cage structure is positioned inside the HSS steel structural beam.

3. The female member of claim 2 wherein the external ledge is configured for soldering to the periphery of the HSS steel structural beam when the cage structure is positioned inside the HSS steel structural beam.

4. The female member of claim 2 wherein the external ledge has a plurality of apertures spaced from one another around the cage structure, the plurality of apertures parallel to the engagement axis, the external ledge configured for fastening to the HSS steel structural beam.

5. The female member of claim 1 wherein the housing is configured for fastening to the HSS steel structural beam.

6. The female member of claim 5 wherein the cage structure has an aperture defined transversally to the engagement axis, configured to be aligned with a corresponding aperture defined in the HSS steel structural beam for engagement by a fastener when the cage structure is positioned inside the HSS steel structural beam.

7. The female member of claim 1, in combination with the HSS steel structural beam, wherein the cage structure is positioned inside the HSS steel structural beam.

8. The female member of claim 1 wherein the HSS steel structural beam is a first HSS steel structural beam, further comprising a second HSS steel structural beam, and a male member having the shaft, the male member integrated to the second HSS steel structural beam.

9. The female member of claim 8 wherein the shaft has a head abutting against a face of a male member support plate and secured to the male member support plate, the support plate being secured to the second HSS steel structural beam.

10. The female member of claim 1 wherein the locking members have proximal ends slidingly engaged against the support plate.

11. The female member of claim 10 wherein the proximal ends of the locking members broaden in the direction of the support plate.

12. The female member of claim 10 further comprising a reinforcement plate secured to the support plate and slidingly engaged by the proximal ends of the locking members.

13-20. (canceled)

21. The female member of claim 1, further comprising a tumbler inside the cage structure, the tumbler having a plurality of stops, the locking members having a plurality of abutments, the abutments being engaged with the stops and opposing the bias when the tumbler is at an armed position, and disengaged from the stops when the tumbler is moved from the armed position to an engagement position, in which engagement position the bias can move the locking members.
